(19) United States
(12) Patent Application Publication
(10) Pub. No.: US 2018/0016528 A9
(43) Pub. Date: Jan. 18, 2018

(54) METHOD OF TREATING A METAL SUBSTRATE

(71) Applicant: Xeros Limited, Rotherham (GB)

(72) Inventors: John Edward Steele, Rotherham (GB); Robert Andrew Bird, Rotherham (GB)

(73) Assignee: Xeros Limited, Rotherham (GB)

(21) Appl. No.: 14/902,498

(22) PCT Filed: Mar. 3, 2014
(86) PCT No.: PCT/GB2014/050620

§ 371 Date: Dec. 31, 2015

(30) Foreign Application Priority Data
Jul. 5, 2013 (GB) 1312158.7

(51) Int. Cl. C11D 17/00; C23G 1/02; C23G 1/19; C23G 1/14; C23G 1/12; C23G 1/08; C23G 1/00; C11D 11/00; C11D 3/37; C11D 3/28; C11D 3/20; C11D 3/00; B24C 1/00; B08B 3/08; C23G 1/22; C23G 1/26

(52) U.S. Cl. CPC C11D 17/0013; C23G 1/26; C23G 1/025; C23G 1/19; C23G 1/14; C23G 1/125; C23G 1/088; C23G 1/02; C23G 1/00; C11D 11/0029; C11D 3/3749; C11D 3/3719; C11D 3/3715; C11D 3/28; C11D 3/2086; C11D 3/2075; C11D 3/0073; B24C 1/00; B08B 3/08; C23G 1/22

(57) ABSTRACT

A method of removing at least a portion of an oxide layer from the surface of a metal substrate comprising exposing the metal substrate to a body of treatment liquor comprising a treatment formulation and a multiplicity of solid particles which comprise or consists of a multiplicity of polymeric particles and wherein said treatment formulation comprises one or more promoters selected from the group consisting of acids, bases and surfactants wherein the method further comprises causing the solid particles and the metal substrate to enter into contacting relative movement.

Embodiments of the present invention relate to a method of treating a metal substrate. The treatment can comprise contacting the metal substrate with a material comprising or consisting of solid particles and a treatment formulation. In embodiments, the method of the invention can result in removal of at least a portion of an oxide layer from the surface of the substrate.

### BACKGROUND

Metal substrates can have a surface bound layer of material present at the metal substrate surface, such as a metal oxide layer. In some instances, removal or modification of such a surface bound layer can be desirable. Modification of the surface bound layer can involve its partial removal, such as to make the layer more uniform across the metal substrate surface. Total removal, or substantially total removal, of the surface bound layer can be desirable in some instances. Such steps can be desirable in order to render the metal substrate surface suitable for further treatments, such as surface coating treatments.

Current methods for treating metal substrates, and particularly those that involve modification of the metal surface, often require large quantities of water in combination with toxic chemicals and aggressive conditions. The use of such toxic chemicals and aggressive conditions presents a number of problems which can compromise the success of the treatment and/or have negative environmental consequences.

Abrasive cleaning methods are sometimes used for oxide layer removal from a metal substrate surface. However, conventional abrasive methods, for example sand blasting processes, tend to be only temporarily effective and can damage the substrate. Furthermore, abrasive methods may not achieve consistency of removal of excess material from the substrate, leading to a non-uniform surface.

As noted above, surface uniformity can be particularly important when metal substrates are to undergo additional treatments such as the application of one or more coatings or lacquers. Certain metal substrates, for example aluminum, undergo oxidation to form an oxide layer when exposed to air. In manufacturing processes for aluminum-based products, the oxide layer can become damaged leading to a non-uniform surface which can compromise the success of subsequent surface treatment steps.

Conventional aluminum production processes, and particularly those for the production of aluminum cans, therefore include a step to remove the damaged or non-uniform oxide layer. Typically, this step is performed using hydrofluoric acid. Following exposure of the aluminum product to hydrofluoric acid, it is then necessary to rinse the substrate thoroughly with water to remove this corrosive and harmful substance prior to any subsequent treatment.

As alluded to above, the use of hydrofluoric acid to remove an oxide layer has both environmental and cost implications, especially as the disposal of waste hydrofluoric acid is subject to strict regulations. Furthermore, large volumes of water are required for rinsing the metal substrate adding to the undesirable environmental consequences arising from the process.

Metal substrates can be, or can become, contaminated for various reasons. One common cause of contamination is earlier treatment processes in forming or modifying the metal substrate. As a result of such earlier treatment processes, the metal substrate surface can carry contaminants such as fines (small particles of the metal) and smut, lubricants such as oils, lubricant residues, coolant residues, inorganic or organic salts, surfactants, biocides, emulsifiers and fungicides. Some or all of these materials can require removal prior to subsequent further treatment or modification of the metal substrate.

Cleaning the surfaces of metal substrates can require aggressive conditions such as strongly acidic compositions to elicit an effective cleaning action. The use of aggressive cleaning conditions and chemicals presents a number of problems including the disposal of hazardous effluent produced from the cleaning process.

Prior to the development of the method disclosed herein, the inventors have previously addressed the problem of reducing water consumption in a domestic or industrial cleaning method. WO2007/128962 discloses in its broadest aspect a method and formulation for cleaning a soiled substrate, the method comprising the treatment of the moistened substrate with a formulation comprising a multiplicity of polymeric particles, wherein the formulation is free of organic solvents. WO2007/128962 is primarily directed to the cleaning of textile substrates. Cleaning of non-textile substrates is mentioned by one reference to plastics, leather, paper, cardboard, metal, glass or wood. Disclosed polymeric particles are particles of polyamides (including nylon), polyesters, polyalkenes, polyurethanes or their copolymers.

The above-mentioned prior art method has been successful in providing an efficient means of textile cleaning and stain removal while achieving significantly reduced water consumption for domestic and industrial laundry processes. The method of WO2007/128962 is not therefore specifically directed to the treatment of metal substrates.

The present disclosure seeks to provide a method of treating a metal substrate which can ameliorate or overcome one or more of the above-noted problems associated with the prior art. Particularly, there is desired a method which can provide an improved means of removing at least a portion of an oxide layer from the surface of the metal substrate. Furthermore, there is desired a method whereby the volume of polluting and hazardous effluent produced from such a process can be reduced. Also, there is desired a treatment liquor suited to the removal of at least a portion of an oxide layer from the surface of a metal substrate which can be used in said method.

### BRIEF SUMMARY OF THE DISCLOSURE

In embodiments of the present invention there is provided a method of removing at least a portion of an oxide layer from the surface of a metal substrate. The method can comprise exposing the metal substrate to a body of treatment liquor comprising a treatment formulation and a multiplicity of solid particles. The treatment formulation can comprise one or more promoters selected from the group consisting of acids, bases and surfactants. The method can comprise causing the solid particles and the metal substrate to enter into contacting relative movement.

In one embodiment of the present invention there is provided a method of removing at least a portion of an oxide layer from the surface of a metal substrate comprising exposing the metal substrate to a body of treatment liquor comprising a treatment formulation and a multiplicity of solid particles which comprise or consists of a multiplicity of polymeric particles and wherein said treatment formulation comprises one or more promoters selected from the group consisting of acids, bases and surfactants wherein the method further comprises causing the solid particles and the metal substrate to enter into contacting relative movement.

In some embodiments there is provided a treatment liquor for removing at least a portion of an oxide layer from the surface of a metal substrate. The treatment liquor treatment liquor can comprise a treatment formulation and a multiplicity of solid particles. The treatment formulation can comprise one or more promoters selected from the group consisting of acids, bases and surfactants.

In another embodiment of the present invention there is provided a treatment liquor for removing at least a portion of an oxide layer from the surface of a metal substrate comprising a treatment formulation and a multiplicity of solid particles which comprise or consists of a multiplicity of polymeric particles wherein said treatment formulation comprises one or more promoters selected from the group consisting of acids, bases and surfactants, wherein said treatment formulation comprises:
i) one or more promoters comprising at least one carboxylic acid moiety;
ii) one or more promoters comprising at least one surfactant; and wherein the particles have a length of from about 0.5 to about 6 mm.

In embodiments, the method of the invention can facilitate the removal of an oxide layer from the surface of a metal substrate without requiring the use of highly aggressive conditions.

In some embodiments, the treatment formulation further comprises a solvent.

In some embodiments, the acids can have a pKa greater than about −1.7. In further embodiments, the acids can have a pKa between about −1.7 and about 15.7.

In some embodiments, the one or more promoters comprise at least one organic acid.

In some embodiments, the bases can have a pKb greater than about −1.7. In further embodiments, the bases can have a pKb between about −1.7 and about 15.7.

In some embodiments, the one or more promoters can comprise at least one carboxylic acid moiety.

In some embodiments, the one or more promoters can comprise two or more carboxylic acid moieties.

In some embodiments, the one or more promoters can comprise at least one citrate moiety.

In some embodiments, the one or more promoters can comprise at least one metal chelating agent.

In some embodiments, the one or more promoters can comprise at least one surfactant.

In some embodiments, the at least one surfactant can be a non-ionic surfactant.

In some embodiments, the treatment formulation can have a pH between about 1 and about 13.

In some embodiments, the treatment formulation can have a pH greater than about 7.

In some embodiments, the treatment formulation can have a pH of about 8.

In some embodiments, the treatment formulation can be aqueous.

In some embodiments, at least some of the solid particles can be buoyant in the treatment formulation.

In some embodiments, the solid particles can have an average density of less than about 1.

In some embodiments, the solid particles can be of hollow and/or porous construction.

In some embodiments, the solid particles can be in the form of beads.

In some embodiments, the method can comprise moving the metal substrate such that its surface is brought into contact with the solid particles.

In some embodiments, the method can comprise rotating, oscillating or reciprocating the metal substrate within the treatment liquor.

In an embodiment, the method can comprise scouring the surface of the metal substrate with the solid particles.

In some embodiments, the method can comprise agitating the solid particles within the treatment liquor.

In some embodiments, the method can be carried out using a fluidized bed containing the treatment liquor.

In some embodiments, the multiplicity of solid particles can comprise a multiplicity of polymeric particles. In other embodiments the multiplicity of solid particles can consist of a multiplicity of polymeric particles.

In some embodiments, the multiplicity of solid particles can comprise a multiplicity of non-polymeric particles. In further embodiments, the multiplicity of solid particles can consist of a multiplicity of non-polymeric particles.

In some embodiments, the multiplicity of solid particles can comprise a mixture of a multiplicity of polymeric particles and a multiplicity of non-polymeric particles. In other embodiments the multiplicity of solid particles can consist of a mixture of a multiplicity of polymeric particles and a multiplicity of non-polymeric particles.

In some embodiments, the polymeric particles can comprise particles of one or more polar polymers. By polar we preferably mean that the polymer has carbon atoms bonded to one or more electronegative atoms, preferably selected from a halogen, oxygen, sulfur and nitrogen atoms. In some embodiments, the polymeric particles can comprise particles of one or more non-polar polymers. By non-polar we preferably mean that the polymer has no carbon atoms bonded to one or one or more electronegative atoms, preferably selected from a halogen, oxygen, sulfur and nitrogen atoms.

In some embodiments, the polymeric particles can comprise particles of one or more polar polymers and particles of one or more non-polar polymers.

In some embodiments, the polymeric particles can comprise particles selected from particles of polyalkenes, polyamides, polyesters, polysiloxanes, polyurethanes and copolymers thereof.

In some embodiments, the polymeric particles can comprise particles selected from particles of polyalkenes and copolymers thereof.

In some embodiments, the polymeric particles can comprise particles of polypropylene.

In some embodiments, the polymeric particles can comprise particles selected from polyamide, polyester and copolymers thereof.

In some embodiments, the polyester particles can comprise particles of polyethylene terephthalate or polybutylene terephthalate.

In some embodiments, the polyamide particles can comprise particles of nylon.

In some embodiments, the polyamide particles can comprise Nylon 6 or Nylon 6,6.

In some embodiments, the non-polymeric particles can comprise particles of ceramic material, refractory material, igneous, sedimentary, metamorphic minerals or composites.

In some embodiments, the polymeric particles or non-polymeric particles can be in the form of beads.

In some embodiments, the polymeric particles can comprise particles selected from particles comprising linear, branched or cross-linked polymers.

In some embodiments, the polymeric particles can comprise foamed polymers.

In some embodiments, the polymeric particles can comprise unfoamed polymers.

In some embodiments, the polymeric particles or non-polymeric particles can be of hollow and/or porous construction.

In some embodiments, the polymeric particles can have a density of from about 0.5 to about 3.5 g/cm³.

In some embodiments, the non-polymeric particles can have a density of from about 3.5 to about 12.0 g/cm³.

In some embodiments, the polymeric or non-polymeric particles can have a volume in the range of about 5 to about 275 mm³.

In some embodiments, the solid particles can be reused one or more times for treatment of metal substrates according to the method of the invention.

In some embodiments the method can further comprise a step of recovering the multiplicity of solid particles after treatment of the metal substrate. In further embodiments, the method can comprise separating the multiplicity of solid particles from the treatment formulation.

In some embodiments, the treatment formulation can be substantially free from hydrofluoric acid.

In some embodiments, the treatment formulation can comprise one or more components selected from the group consisting of: polymers, corrosion inhibitors, builders, dispersants, anti-oxidants, reducing agents, oxidising agents and bleaches.

In some embodiments, the method can comprise passivating the metal substrate.

In some embodiments, the method can comprise inhibiting the re-growth of an oxide layer on the surface of the metal substrate.

In some embodiments, the method can further comprise coating the metal substrate after the removal of at least a portion of the oxide layer. The coating can be a protective coating or lacquer.

In some embodiments, the metal substrate can comprise a transition metal.

In some embodiments, the metal substrate can comprise aluminum.

In some embodiments, the metal substrate can be a metal alloy.

In some embodiments, the metal substrate can comprise a metal sheet.

In some embodiments, the metal substrate can be a metal can.

In some embodiments the method can further comprise shaping or forming the metal substrate. Said shaping or forming can be prior to, or subsequent to, the treatment step of the method of the invention. The shaping or forming of the substrate can be to create a final desired form of an article, such as a can, or to form a precursor to said final desired form.

In some embodiments, the method of the invention can further comprise, prior to the removal of at least a portion of the oxide layer from the metal substrate, cleaning the metal substrate to remove surface contaminants. In some embodiments, cleaning the metal substrate can comprise cleaning the metal substrate with a cleaning liquor comprising a cleaning formulation and a multiplicity of solid particles.

In some embodiments cleaning the metal substrate can further comprise causing the solid particles and the metal substrate to enter into contacting relative movement.

In some embodiments, the cleaning formulation can comprise at least one solvent.

In some embodiments, the cleaning formulation can be aqueous.

In some embodiments, the cleaning formulation can comprise at least one surfactant.

In some embodiments, the cleaning formulation can comprise at least one acid.

In some embodiments the cleaning formulation can comprise at least one base.

In some embodiments, the cleaning formulation can comprise at least one metal chelating agent.

In some embodiments, the cleaning formulation can comprise at least one citrate moiety.

In some embodiments, the solid particles can be in accordance with the solid particles disclosed hereinabove in embodiments of the invention relating to oxide layer removal.

In further embodiments of the invention there is disclosed a metal substrate obtained or obtainable by the method of embodiments of the invention hereinabove disclosed.

In some embodiments, the metal substrate can comprise an oxide layer with a thickness of less than 15 nm as measured by X-ray photoelectron spectroscopy.

In some embodiments, the metal substrate can comprise an oxide layer with a thickness of less than 10 nm as measured by X-ray photoelectron spectroscopy.

In some embodiments, the metal substrate can comprise an oxide layer with a thickness of less than 6 nm as measured by X-ray photoelectron spectroscopy.

In some embodiments, the metal substrate can comprise an oxide layer with a thickness of less than 5.4 nm as measured by X-ray photoelectron spectroscopy.

In some embodiments, the metal substrate can comprise an oxide layer with a thickness of less than 3.8 nm as measured by X-ray photoelectron spectroscopy.

In some embodiments the method of the invention can be continued until the oxide layer has a thickness of less than 15 nm as measured by X-ray photoelectron spectroscopy (XPS) such as less than 10 nm, or less than 6 nm, or less than 5.4 nm and in particular less than 4.1 nm, such as less than 3.8 nm.

### BRIEF DESCRIPTION OF THE DRAWING

FIG. 1 shows a pre-corroded mild steel substrate, the pre-corroded mild steel substrate treated after treatment in accordance with the invention and (c) is an un-corroded mild steel substrate

### DETAILED DESCRIPTION

In certain embodiments the method of the present invention can involve removing at least a portion of an oxide layer from the surface of a metal substrate. In other embodiments, the method of the present invention can involve removing substantially all of the oxide layer from the surface of the metal substrate. Oxide layer removal, or partial removal, can be achieved by contacting the metal substrate with a treatment formulation and a multiplicity of solid particles (also referred to herein as “a solid particulate material”). The metal substrate can be contacted with the solid particulate material and the treatment formulation such that the solid particulate material can cause a change or modification in the surface of the metal substrate which can lead to or result in the removal or partial removal of an oxide layer.

The contact with the metal substrate surface can comprise a mechanical interaction and, in order to achieve this effect, contacting relative motion can be imparted between the metal substrate and the solid particulate material. The treatment liquor can comprise a treatment formulation, which is typically a liquid phase, and the solid particulate material which can optionally be suspended in, or dispersed throughout, the treatment formulation.

In certain embodiments, the density of particulate material in the treatment liquor (that is, the number of particles per unit volume of treatment liquor) can be such that any given particle is in frequent, or substantially continuous, contact with the adjacent particles. Thus, in some embodiments, the treatment liquor can be densely populated with the solid particulate material such that it is in the form of a slurry.

In further embodiments, a stream of treatment liquor can be directed at the surface of the metal substrate. The method of the invention can therefore include the use of spraying devices such as pressurized nozzles or the like to direct the treatment liquor at the metal substrate surface.

In other embodiments, the metal substrate can be moved so that its surface is brought into contact with the solid particulate material. Such an interaction can be achieved by rotating or oscillating the metal substrate when suspended by a holding device at an appropriate position within a portion of the treatment liquor containing the solid particulate material. For example, the formulation comprising the solid particulate material can be contained within a suitably sized treatment vessel or chamber with the metal substrate attached to a movable arm or gripping means which can be configured for rotation and/or oscillation and/or reciprocation.

The speed, rate or extent of rotation and/or oscillation and/or reciprocation can be varied to increase or decrease the degree of mechanical interaction between the metal substrate surface and the solid particulate material. Alternatively, or in addition, the solid particulate material can itself be stimulated to move such that the solid particles are constantly in motion within the treatment liquor.

In preferred embodiments the treatment liquor contacts the metal surface at a relative velocity of at least 1 cm/s, more preferably at least 10 cm/s, even more preferably at least 50 cm/s and especially at least 100 cm/s. Preferably, the treatment liquor contacts the metal surface at a relative velocity of no more than 100 m/s, more preferably no more than 50 m/s and especially no more than 10 m/s per second.

In some embodiments it is preferred that the solid particles contact the metal substrate at a frequency of at least 1, more preferably at least 10, even more preferably at least 100 and especially at least 1000 particles per second per cm² of surface of the metal substrate. In some embodiments it is preferred that the solid particles contact the metal substrate at a frequency of no more than 1,000,000, more preferably no more than 100,000 and especially no more than 10,000 particles per second per cm² of surface of the metal substrate. In one suitable construction, the method can utilize an agitating device such as an aerator to bubble gas through the treatment liquor at a rate sufficient to agitate the solid particulate material. In certain embodiments, at least some of, and, in some embodiments, substantially all of, the solid particles can be buoyant with respect to the treatment liquor or formulation. Buoyant particles can be particularly suitable in embodiments in which an agitating device such as an aerator is used to bubble gas through the cleaning liquor at a rate sufficient to agitate the solid particulate material.

In certain embodiments of the invention the treatment formulation comprises one or more promoters selected from the group consisting of acids, bases and surfactants. It is believed that the inclusion in some embodiments of the invention of said one or more promoters in the treatment formulation can increase the molecular interactions of the treatment formulation with the metal substrate and/or assist in the removal of at least a portion of the oxide layer.

In some embodiments the treatment formulation can include acids selected from, but not limited to, carboxylic acids such as citric acid, gluconic acid, adipic acid, acetic acid, lactic acid, glycolic acid, oxalic acid and formic acid, polycarboxylates such as succinic acid, oxydisuccinic acid, carboxymethyloxysuccinic acid, polymaleic acid, mellitic acid and benzene 1,3,5-tricarboxylic acid, phosphates such as sodium hydrogen phosphate, sodium dihydrogen phosphate and zinc hydrogen phosphate, sulphate and sulphite containing compounds such as sodium bisulphate, sodium bisulphite, iron (II) sulphate and iron (III) sulphate, sulphonic acids such as methane sulphonic acid, phenol sulphonic acid, toluene sulphonic acid, acrylamido-2-methylpropanesulphonic acid and polyvinylsulphonic acid, polyacetic acids such as ethylenediamine tetraacetic acid and nitrilotriacetic acid, weak acids such as phosphoric acid, carbonic acid and hydrogen peroxide, and others including ascorbic acid and acidic ion exchange resins based on sulphonic acids such as acrylamido-2-methylpropanesulphonic acid and chelating resins based on dicarboxylic acids such as iminodiacetic acid.

In some embodiments of the invention the acids and bases can have dissociation or ionization constants within a specified range. Thus the acids can have particular pKa values in a dilute aqueous solution, wherein pKa is defined as the negative of the logarithm of the equilibrium constant Ka for the reaction:

HA [symbol] H⁺+A⁻

i.e., Ka=[H⁺][A⁻]/[HA]

where [H⁺], etc. represent the concentrations of the respective species in mol/L. It follows that pKa=pH+log [HA]−log [A⁻], so a solution with 50% dissociation has pH equal to the pKa of the acid.

In some embodiments of the invention the acids can have pKa values greater than about −1.7. In further embodiments, the acids can have pKa values between about −1.7 and about 15.7 (the pKa of water). In still further embodiments, the acids can have pKa values greater than about 1. In certain embodiments, the acids can have pKa values between about 1 and about 15.7. In still further embodiments, the acids can have pKa values between about 1 and about 12. In embodiments of the invention containing polyprotic acids, each pKa value can be in accordance with the ranges specified above (for example, the acidic compound may contain more than one pKa value each which is greater than about −1.7). Thus in some embodiments of the invention, the acids of the treatment formulation are weaker than strong acids with pKa values of less than −1.7 (e.g. sulphuric acid or hydrochloric acid) that are commonly employed in methods of the prior art. In some embodiments it is preferred that no acid present in the treatment formulation has a pKa of less than or equal to about −1.7, more preferably no acids present in the treatment formulation have a pKa outside about −1.7 to about 15.7, even more preferably no acids presents in the treatment formulation have a pKa outside about 1 to about 12. In some embodiments the treatment formulation does not comprise a mineral acid (examples of which include sulphuric acid, hydrochloric acid, hydrofluoric acid, hydriodic acid, nitric acid and phosphoric acid).

In some embodiments the treatment formulation can include bases selected from, but not limited to, one or more alkali metal containing compounds and/or salts thereof such as sodium polyacrylate, sodium acrylamido-2-methylpropanesulphonate, sodium polyvinylsulphonate, sodium carbonate, sodium hydrogen carbonate, sodium citrate, trisodium citrate, sodium oxalate, sodium phosphate, sodium phenol sulphonate, sodium toluene sulphonate, sodium methane sulphonate, sodium lactate, sodium gluconate, sodium glycolate and sodium formate and others including zinc phosphate, poly (acrylamido-N-propyltrimethylammonium chloride), polyethylene amine, zinc dithiophosphate, benzalkonium chloride, alkylaminophosphates plus the alkali metal salts of polyphosphates, ammonium salts of polyphosphates and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, alkali metal salts of polyacetic acids, ammonium salts of polyacetic acids, substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid and soluble salts thereof and basic ion exchange resins including those based on quaternary amino groups such as trimethylammonium groups, for example, poly (acrylamido-N-propyltrimethylammonium chloride).

Thus in some embodiments of the invention the treatment of the metal substrate can be performed using bases as opposed to the acidic reagents typically employed in methods of the prior art.

As noted above, in some embodiments of the invention the bases can have ionization constants within a specified range. Thus the bases can have particular pKb values in a dilute aqueous solution, wherein the logarithm of the ionisation constant, pKb, is derived from the reaction: B+H₂O [symbol] BH⁺+OH⁻. This is related to Ka by:

pKa+pKb=pK_{water}=14.00 (at 25° C.).

In some embodiments of the invention the bases can have pKb values greater than about −1.7. In further embodiments, the bases can have pKb values between about −1.7 and about 15.7 (the pKa of water). In still further embodiments, the bases can have pKb values greater than about 1. In certain embodiments, the bases can have pKb values between about 1 and about 15.7. In still further embodiments, the bases can have pKb values between about 1 and about 12. In some embodiments it is preferred that no base present in the treatment formulation has a pKb of less than or equal to about −1.7, more preferably no bases presents in the treatment formulation have a pKb outside about −1.7 to about 15.7, even more preferably no bases presents in the treatment formulation have a pKa outside about 1 to about 12.

In some embodiments of the invention, the one or more promoters of the treatment formulation can comprise a compound with at least one carboxylic acid moiety. In further embodiments, the treatment formulation can comprise a compound with two or more carboxylic acid moieties. In still further embodiments, the treatment formulation can comprise a compound with at least three carboxylic acid moieties.

In certain embodiments, the treatment formulation can comprise at least one citrate moiety and can include, for example, citrate containing salts such as sodium citrate and trisodium citrate.

In some embodiments of the invention, the one or more promoters of the treatment formulation can comprise one or more metal chelating agents.

In some embodiments, the one or more promoters of the treatment formulation can comprise at least one surfactant. The treatment formulation can thus include one or more surfactants selected from non-ionic surfactants, anionic surfactants, cationic surfactants, ampholytic and/or zwitterionic surfactants and semi-polar nonionic surfactants. It is believed that the presence of a surfactant in the formulation can facilitate a bonding interaction with the surface of the metal substrate enhancing the effect of the treatment. The surfactant may also reduce the surface tension of the treatment formulation allowing better contact between the solid particles, the treatment formulation and the metal substrate. The surfactant may also help to suspend small particles of metal oxide and or other surface impurities which are removed from the surface of the metal substrate.

In some embodiments of the invention, the formulation can comprise a non-ionic surfactant. Examples of suitable non-ionic surfactants can include, but are not limited to, Mulan 200S®, alcohol ethoxylates (e.g. C14-15 alcohol 7 mole ethoxylate (Neodol 45-7)), polyoxyethylene glycol alkyl ethers (e.g. Brij®, octaethylene glycol monododecyl ether and pentaethylene glycol monododecyl ether), polyoxypropylene glycol alkyl ethers, glucoside alkyl ethers (e.g. decyl glucoside, lauryl glucoside, octyl glucoside), polyoxyethylene glycol octylphenol ethers, polyoxyethylene glycol alkylphenol ethers, glycerol alkyl esters (e.g. glycerol laurate), polyoxyethylene glycol sorbitan alkyl esters (e.g. polysorbate), sorbitan alkyl esters (e.g. spans), cocamide MEA, coamide DEA, dodecyldimethylamine oxide, block copolymers of polyethylene glycol and polypropylene glycol (e.g. poloxamers), polyethoxylated tallow amine (POEA).

The solid particulate material for use in the method of the invention can comprise a multiplicity of polymeric particles or a multiplicity of non-polymeric particles. In some embodiments, the solid particulate material can comprise a multiplicity of polymeric particles. Alternatively, the solid particulate material can comprise a mixture of polymeric particles and non-polymeric particles. In such embodiments, the mixture can contain predominantly polymeric particles. In other embodiments, the solid particulate material can comprise a multiplicity of non-polymeric particles. Thus the solid particulate material in embodiments of the invention can comprise exclusively polymeric particles, exclusively non-polymeric particles or mixtures of polymeric and non-polymeric particles.

The polymeric or non-polymeric particles can be of such a shape and size as to allow for intimate contact with the surface of the metal substrate. A variety of shapes of particles can be used, such as cylindrical, spherical or cuboid; appropriate cross-sectional shapes can be employed including, for example, annular ring, dog-bone and circular. The particles can have smooth or irregular surface structures and can be of solid, porous or hollow structure or construction. For example, in embodiments wherein the solid particulate material is buoyant, the solid particulate material can conveniently comprise polymeric or non-polymeric particles which are hollow or porous to confer buoyant properties to said particulate material. In some embodiments, the polymeric or non-polymeric particles can comprise cylindrical or spherical beads.

In some embodiments the polymeric particles can be of such a size as to have an average mass of about 0.001 mg to about 250 g. In further embodiments the polymeric particles can be of such a size as to have an average mass of about 0.001 mg to about 10 g. In still further embodiments the polymeric particles can be of such a size as to have an average mass of about 0.001 mg to about 1 g. In yet further embodiments the polymeric particles can be of such a size as to have an average mass of about 1 mg to about 100 mg. In still further embodiments the polymeric particles can be of such a size as to have an average mass of about 5 mg to about 100 mg.

In some embodiments the non-polymeric particles can be of such a size as to have an average mass of about 0.001 mg to about 250 g. In further embodiments the non-polymeric particles can be of such a size as to have an average mass of about 0.001 mg to about 10 g. In still further embodiments the non-polymeric particles can be of such a size as to have an average mass of about 0.001 mg to about 1 g. In yet further embodiments the non-polymeric particles can be of such a size as to have an average mass of about 1 mg to about 100 mg. In still further embodiments the non-polymeric particles can be of such a size as to have an average mass of about 5 mg to about 100 mg.

In embodiments of the invention, the length of the particle can be from about 1 micron (1 micrometre) to about 500 mm. In other embodiments the length of the particle can be from about 0.1 mm to about 500 mm. In further embodiments the length of the particle can be from about 0.5 mm to about 25 mm. In still further embodiments the length of the particle can be from about 0.5 mm to about 6 mm. In still further embodiments the length of the particle can be from about 1.5 mm to about 4.5 mm. In yet further embodiments the length of the particle can be from about 2.0 mm to about 3 mm. The length of the particle is preferably defined as the maximal linear spacing between two points on the surface of the particle.

The polymeric particles can comprise particles of polar polymers. It is believed that the inclusion of particles of polar polymers in the method of the invention, for example polyamides, can improve the interaction with the metal oxide layer.

Alternatively, or in addition, the polymeric particles can comprise particles of non-polar polymers. Again, it is believed that the inclusion of particles of non-polar polymers in the method of the invention, for example polypropylene, can enhance the cleaning of unwanted materials such as contaminants from the surface of the metal. In some embodiments, the polymeric particles can comprise a mixture of polar and non-polar polymer particles.

The polymeric particles can comprise polyalkenes such as polyethylene and polypropylene, polyamides, polyesters, polysiloxanes or polyurethanes. Furthermore, said polymers can be linear, branched or crosslinked. In certain embodiments, said polymeric particles can comprise polyamide or polyester particles, particularly particles of nylon, polyethylene terephthalate or polybutylene terephthalate, typically in the form of beads. Copolymers of the above-polymeric materials can also be employed in embodiments of the invention. The properties of the polymeric materials can be tailored to specific requirements by the inclusion of monomeric units which confer particular properties on the copolymer. Various nylon homo- or co-polymers can be used including, but not limited to, Nylon 6 and Nylon 6,6. In an embodiment, the nylon can comprise Nylon 6,6 copolymer, preferably having a molecular weight in the region of from about 5000 to about 30000 Daltons, such as from about 10000 to about 20000 Daltons, or such as from about 15000 to about 16000 Daltons. Useful polyesters can have a molecular weight corresponding to an intrinsic viscosity measurement in the range of from about 0.3 to about 1.5 dl/g, as measured by a solution technique such as ASTM D-4603.

In some embodiments, the polymeric or non-polymeric particles can have an average density of less than about 1. In certain embodiments, the polymeric or non-polymeric particles can have an average density of about 0.5 to about 0.99 g/cm³.

In other embodiments, the polymeric or non-polymeric particles can have an average density in the range of about 0.5 to about 20 g/cm³. In some embodiments the polymeric particles, or the non-polymeric particles, can have an average density in the range of about 0.5 to about 12 g/cm³. In still other embodiments the polymeric particles, or the non-polymeric particles, can have an average density in the range of about 0.5 to about 3.5 g/cm³. In still further embodiments the polymeric particles or the non-polymeric particles can have an average density in the range of about 0.5 to about 2.5 g/cm³.

In some embodiments, the polymeric or non-polymeric particles can have an average volume of about 5 to about 275 mm³. In further embodiments, the polymeric or non-polymeric particles can have an average volume of about 8 to about 140 mm³. In still further embodiments, the polymeric or non-polymeric particles can have an average volume of about 10 to about 120 mm³.

In some embodiments, the polymeric particles can have an average density in the range of from about 0.5 to about 3.5 g/cm³ and an average volume of about 5 to about 275 mm³.

In some embodiments, the polymeric particles can have an average density in the range of from about 0.5 to about 2.5 g/cm³. In further embodiments the polymeric particles can have an average density in the range of from about 0.55 to about 2.0 g/cm³. In still further embodiments the polymeric particles can have an average density in the range of from about 0.6 to about 1.9 g/cm³.

In certain embodiments, the non-polymeric particles can have an average density greater than the polymeric particles. Thus, in some embodiments, the non-polymeric particles can have an average density in the range of about 0.5 to about 20 g/cm3. In further embodiments, the non-polymeric particles can have an average density in the range of about 3.5 to about 12.0 g/cm³. In still further embodiments, the non-polymeric particles can have an average density in the range of about 5.0 to about 10.0 g/cm³. In yet further embodiments, the non-polymeric particles can have an average density in the range of about 6.0 to about 9.0 g/cm³.

In some embodiments, the solid particulate material can comprise non-polymeric particles. The non-polymeric particles can be selected from particles of ceramic material, refractory material, igneous, sedimentary, metamorphic minerals and composites. Suitable ceramics can include, but are not limited to, alumina, zirconia, tungsten carbide, silicon carbide and silicon nitride.

In certain embodiments, the method of the invention can comprise scouring the surface of the metal substrate with the solid particles. Thus in some embodiments, the solid particles can be abrasive or have some abrasive qualities.

In some embodiments the treatment formulation can further comprise one or more solvents. Suitable solvents that can be contained in the treatment formulation can include, but are not limited to, water, polar solvents and non-polar solvents.

In some embodiments, water is the preferred solvent. Other suitable solvents can include alcohols (especially ethanol and isopropanol), glycols and glycol mono and di-ethers, cyclic amides (e.g. pyrrolidone and methyl pyrrolidone). In some embodiments the amount of solvents other than water is less than 10 wt %, more preferably less than 5 wt %, especially less than 2 wt % and most especially less than 0.5 wt % of the treatment formulation. In some embodiments the only solvent present in the treatment formulation is water.

In certain embodiments of the invention, the treatment formulation can comprise water. As a more effective treatment can be provided due to the enhanced interaction between the metal substrate surface and the components of the treatment formulation, the quantity of any water used in some advantageous embodiments can be significantly reduced compared to methods of the prior art.

In some embodiments, the treatment formulation of the invention can comprise one or more auxiliary components selected from the group consisting of: polymers, corrosion inhibitors, anti-oxidants, builders, dispersants, reducing agents, oxidising agents and bleaches.

Suitable polymers that can be contained in the treatment formulation can include, but are not limited to, polyacrylates and polyethylene glycol.

Suitable corrosion inhibitors that can be contained in the treatment formulation include, but are not limited to, benzotriazole, zinc phosphate, zinc dithiophosphate, benzalkonium chloride and alkylaminophosphates.

Suitable anti-oxidants that can be contained in the treatment formulation can include, but are not limited to, sodium bisulphite and ascorbic acid.

Suitable builders that can be contained in the treatment formulation can include, but are not limited to, the alkali metal salts of polyphosphates, ammonium salts of polyphosphates and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, alkali metal salts of polyacetic acids, ammonium salts of polyacetic acids and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid and soluble salts thereof.

Optionally, the treatment formulation can also contain dispersants. Suitable water-soluble organic materials for use as dispersants can be the homo- or co-polymeric polycarboxylic acids or their salts, in which the polycarboxylic acid can comprise at least two carboxyl radicals separated from each other by not more than two carbon atoms.

Suitable reducing agents that can be contained in the treatment formulation can include, but are not limited to, iron (II) sulphate and oxalic acid.

The treatment formulation can include one or more bleaches and/or oxidizing agents. Examples of such bleaches and/or oxidizing agents can include, but are not limited to, ozone, oxygen, peroxygen compounds, including hydrogen peroxide, inorganic peroxy salts, such as perborate, percarbonate, perphosphate, persilicate, and mono persulphate salts (e.g. sodium perborate tetrahydrate and sodium percarbonate), sodium hypochlorite, chromic acid, nitric acid and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. The bleaches and/or oxidizing agents can be activated by a chemical activation agent. Activating agents can include, but are not limited to, carboxylic acid esters such as tetraacetylethylenediamine and sodium nonanoyloxybenzene sulphonate. Alternatively, the bleach compounds and/or oxidizing agents can be activated by heating the formulation. In certain embodiments, the treatment formulation of the invention can have pH greater than 7. In some embodiments the treatment formulation can have pH less than 13 and in further embodiments, the treatment formulation can have pH not less than 1. In some embodiments the treatment formulation can have pH between 1 and 13. In other embodiments, the treatment formulation can have pH from about 2 to about 12. The treatment formulation can therefore have pH values of at or about 2, 3, 4, 5, 6, 7, 8, 9, 10, 11 or 12. In particular embodiments, the formulation can have pH around 8 and specifically the formulation can have pH between 8 and 9. Thus in some embodiments of the invention, the treatment of the metal substrate to remove at least a portion of an oxide layer can be performed in mild conditions as opposed to the harsh acidic conditions commonly employed by methods of the prior art. By mild we preferably mean the treatment formulation has a pH of at least 3, more preferably at least 4, especially at least 5 and/or less than 14, preferably not more than 12, more preferably not more than 11, especially not more than 10 and most especially not more than 9.

In some embodiments the metal substrate is exposed to the treatment liquor for at least 1 second, at least 10 seconds, at least 20 seconds or at least 30 seconds. In some embodiments the metal substrate is exposed to the treatment liquor for no more than 2 hours, no more than 1 hour, no more than 30 minutes, 5 minutes, no more than 4 minutes, no more than 3 minutes or no more than 2 minutes.

In some embodiments, the treatment formulation can be substantially free from hydrofluoric acid. Thus in such embodiments of the invention, the treatment of the metal substrate can be performed in the absence of hydrofluoric acid preferably obviating the need for its costly disposal following completion of the process.

In some embodiments, the method of the invention can comprise passivating the metal substrate. In this context, passivation can be defined as treatment of the metal substrate in order to reduce the reactivity of the metal surface.

The method of embodiments of the invention can provide an oxide layer on the surface of the metal with substantially reduced thickness compared to control samples not treated by the method of the present Invention. Thus in some embodiments, the metal substrate as treated by a method of the invention can comprise an oxide layer with a thickness of less than 15 nm as measured by X-ray photoelectron spectroscopy (XPS). In further embodiments, the metal substrate as treated by a method of the invention can comprise an oxide layer with a thickness of less than 10 nm as measured by XPS. In still further embodiments, the metal substrate as treated by a method of the invention can comprise an oxide layer with a thickness of less than 6 nm as measured by XPS. In yet further embodiments, the metal substrate as treated by a method of the invention can comprise an oxide layer with a thickness of less than 5.4 nm as measured by XPS. In still further embodiments, the metal substrate can comprise an oxide layer with a thickness of less than 4.1 nm as measured by XPS. In yet still further embodiments, the metal substrate can comprise an oxide layer with a thickness of less than 3.8 nm as measured by X-ray photoelectron spectroscopy.

The method of the invention facilitates the removal or partial removal of an oxide layer from the surface of the metal substrate. The oxide layer can, in some embodiments subsequently reform so that the layer is uniform. As such, damaged, discontinuous or non-uniform oxide layers can be replaced by a method of embodiments of the invention. The metal surface homogeneity can thereby be improved. The uniform oxide layer can provide an improved foundation for the application to the metal substrate of one or more coatings or lacquers, or for carrying out subsequent finishing steps on the metal substrate.

In certain embodiments, the method of the invention can inhibit the re-growth of an oxide layer on the surface of the metal. Thus in some embodiments the treatment of the metal surface can facilitate the removal or partial removal of an oxide layer and can also restrict the re-growth or reformation of the oxide layer following exposure of the metal substrate to air.

In certain embodiments, the method can further comprise a method of cleaning the surface of the metal substrate. The cleaning method of these embodiments can be carried out before removing at least a portion of the oxide layer from the surface of the metal substrate. The purpose of the cleaning step can be to remove any deposits or contaminants such as fines (small particles of the metal) and smut, lubricants such as oils, lubricant residues, coolant residues, inorganic of organic salts, surfactants, biocides, emulsifiers and fungicides from the surface of the metal. The deposits or contaminants may, for example, have been derived from earlier processing steps of the metal substrate.

In some embodiments, the cleaning step can comprise a conventional cleaning process, for example, simply rinsing the substrate with water.

In other embodiments, the cleaning step can comprise cleaning the metal substrate with a cleaning liquor comprising a cleaning formulation and a multiplicity of solid particles. The cleaning step can comprise causing the solid particles and the metal substrate to enter into contacting relative movement.

The cleaning formulation can comprise a liquid phase and the solid particles can be suspended in, or dispersed throughout, the cleaning formulation. In certain embodiments, the cleaning formulation can comprise a solvent. In some embodiments, the cleaning formulation can be aqueous. The cleaning liquor can comprise or consist of water and tho solid particles. The multiplicity of solid particles can comprise any one or more of the features as described and outlined herein. In certain embodiments, at least some of, and, in some in embodiments, substantially all of, the solid particles can be buoyant in the cleaning formulation. In further embodiments, the cleaning formulation can comprise at least one component selected from the group consisting of: acids, bases and surfactants in combination with the solid particles. In yet further embodiments, the cleaning formulation can comprise at least one metal chelating agent and the solid particles. In still further embodiments, the cleaning formulation can comprise at least one citrate moiety.

The method of embodiments of the invention can further comprise coating the surface of the metal substrate. In certain embodiments, an additional treatment can be performed to apply one or more coatings after the step for removing the oxide layer from the surface of the metal substrate.

In some embodiments of the invention, the treatment liquor including solid particulate material can be retained for more than one treatment of a metal substrate by the method of the invention. Thus in some embodiments of the invention, the solid particulate material can be reused one or more times. In some embodiments the method of treating can further comprise a step of recovering the multiplicity of solid particles after treating of the metal substrate. In further embodiments, the method of treating can comprise separating the multiplicity of solid particles from the treatment formulation.

The method of embodiments of the invention can be performed with a variety of different metal substrates. In certain embodiments, the metal substrate can comprise a transition metal. In some embodiments, the metal substrate can be aluminum or can comprise aluminum. In some embodiments, the metal substrate can be or can comprise iron. In further embodiments, the metal substrate can be a metal alloy including, but not limited to, alloys of transition metals (for example, alloys of iron such as steel). In other embodiments, the substrate can be a metal-containing composite. Other suitable metal substrates include tantalum, chromium, nickel, uranium, titanium, vanadium, chromium, zinc, tin, lead, copper, cadmium and magnesium. Other suitable metal substrates include rare earth metals such as scandium, yttrium, lanthanum, cerium, praseodymium, neodymium, promethium, samarium, europium, gadolinium, terbium, dysprosium, holmium, erbium, thulium, ytterbium and lutetium. Rare earth metals are often found in nature as the metal oxide and in ores with other metal components. Potentially then, the present invention can have application in rare earth metal extraction, purification or recycling. Some inert metals such as gold and platinum are less prone to forming an oxide layer.

In some embodiments it is preferred that the weight ratio of the treatment formulation to the multiplicity of solid particles is no more than 20:1, more preferably no more than 10:1, even more preferably no more than 5:1, especially no more than 3:1, even more especially no more than 2:1 and most especially no more than 1:1. In some embodiments it is preferred that the weight ratio of the treatment formulation to the multiplicity of solid particles is less than 1:2, more preferably less than 1:3, even more preferably less than 1:5, yet more preferably less than 1:10, especially less than 1:15. These embodiments use desirably small amounts of treatment formulations. In some embodiments it is preferred that the weight ratio of the treatment formulation to the multiplicity of solid particles is no less than 1:100, more preferably no less than 1:50 and especially no less than 1:25. In some embodiments the weight ratio of the treatment formulation to the multiplicity of solid particles is not 14:20. In some embodiments the weight ratio of the treatment formulation to the multiplicity of solid particles is not from 1:2 to 1:1.

In certain embodiments the metal substrate can be a food or beverage container and in particular embodiments the metal substrate can be a can, especially an aluminum can. In other embodiments the metal substrate can be a metal sheet. The metal substrate can, in principle, be in any desired form in accordance with its ultimate intended use. For example, the metal substrate can be in the form of or an as-manufactured metal sheet, sheet metal which has been subjected to post-manufacture treatment steps, metal which has been subjected to cutting or forming steps to achieve a desired shape, a metal blank intended for subsequent forming into a final product, or a substantially finished product in which shaping or forming steps have been substantially completed. An example of a substantially finished product is an open-ended container or can such as for food or beverage use.

The invention will now be further illustrated, though without in any way limiting the scope thereof, by reference to the following examples.

### EXAMPLES

### Experiment 1—Aluminium Oxide Removal and Cleaning Efficiency in a Stirred Vessel.

A series of experiments was conducted to assess the extent of removal of an aluminum oxide layer from a metal substrate which, in this case, was an aluminum can. Furthermore, experiments were undertaken to investigate the cleaning efficiency of formulations prepared in accordance with the method of the invention for the aluminum cans.

The ingredients of the treatment formulation for each experiment, together with sample labels, are listed in Table 1. The surfactant, Mulan™ 200S, was a non-ionic surfactant supplied by Christeyns, Bradford, UK and the citrate component consisted of trisodium citrate dihydrate supplied by VWR, Loughborough, UK. The polymeric particles were Nylon 6,6 grade Technyl™ XA1493 supplied by Solvay, Lyon, France and polypropylene grade 575P Natural, as supplied by SABIC and obtained from Resinex UK Ltd., High Wycombe, UK in the form of beads. The mass of the polymeric particles used in the apparatus was 2000 g. Uncoated aluminum metal cans grade ALJSC60ML63X15 were supplied by Invopak UK Ltd. Hyde, Cheshire, UK.

TABLE 1
Sample details and formulation components

| Sample | Formulation components/treatment |
|---|---|
| Can 1 | Control Can - No Treatment |
| Can 2 | Water Only 1000 g |
| Can 3 | Water 1000 g + |
| | Citrate 200 g + |
| | Non-ionic Surfactant 200 g |
| Can 4 | Nylon polymeric particles 2000 g + |
| | Water 1000 g |
| Can 5 | Nylon polymeric particles 2000 g + |
| | Water 1000 g + |
| | Citrate 200 g + |
| | Non-ionic Surfactant 200 g |
| Can 6 | Polypropylene polymeric particles 2000 g + |
| | Water 1000 g |
| Can 7 | Polypropylene polymeric particles 2000 g + |
| | Water 1000 g + |
| | Citrate 200 g + |
| | Non-ionic Surfactant 200 g |

In order to carry out the experiments, the treatment liquor was added to a vessel. The treatment liquor consisted of the polymeric particles (of total mass 2000 g) and Milli-Q^{™} (Type 1 ISO 3696) water (1000 g) and the further formulation components as shown in Table 1. Aluminum cans were fixed to a metal rod which was attached to an agitator. Each can was inserted into the vessel containing the treatment liquor. The cans were then rotated at approximately 500 rpm in the tub for a period of 30 minutes at a temperature of approximately 22° C., ensuring contact between the can and the treatment liquor. After treatment, the cans were washed with Milli-Q™ water and isopropanol and subjected to X-ray photoelectron spectroscopy (XPS) analysis.

The method for XPS analysis was as follows: The samples were immobilised onto carbon tape for analysis with a Thermo EscaLab 250, using an Al kα monochromated radiation source. A spot size of 500 μm was used for the analysis. An overall survey scan (1250-0 eV) using a pass energy of 150 eV, dwell time of 50 ms and step size of 1 eV was taken initially, followed by detailed scans of the main peaks for the elements identified, using a pass energy of 20 eV, dwell time of 50 ms and step size of 0.1 eV. The measured data was fitted using Casa X-ray photoelectron spectroscopy—XPS (Casa Software Ltd, UK), using relative sensitivity factors based upon the scheme where C1s=1, and adjusted to correct for any minor charging using the aliphatic carbon peak at 285 eV. Each sample was measured in 3 places. XPS spectra were obtained by irradiating a portion of the aluminum can surface with a beam of X-rays while simultaneously measuring the kinetic energy and number of electrons that escape from the top 1 to 10 nm of the material

TABLE 2
XPS results for aluminum oxide removal

| | | | | | Standard |
|---|---|---|---|---|---|
| | | | | Aluminum | Deviation |
| | | | | Oxide | On |
| | | Aluminum | Aluminum | layer | Oxide/ |
| | | Oxide | Metal | Thickness | Metal |
| Sample | Treatment | Area (%) | Area (%) | (nm) | Area (%) |
| Can 1 | Control Can - | 91.9 | 8.1 | 7.90 | 1.3 |
| | No | | | | |
| | Treatment | | | | |
| Can 2 | Water Only | 95.4 | 4.6 | 9.51 | 3.1 |
| Can 3 | Water + | 96.7 | 3.3 | 10.45 | 2.1 |
| | Citrate + | | | | |
| | non-ionic | | | | |
| | surfactant | | | | |
| Can 4 | Nylon + | 92.9 | 7.1 | 8.28 | 3.3 |
| | Water | | | | |
| Can 5 | Nylon + | 80.6 | 19.4 | 5.36 | 1.2 |
| | Water + | | | | |
| | Citrate + | | | | |
| | non-ionic | | | | |
| | surfactant | | | | |

The data shown in Table 2 illustrates the results of XPS analysis for the amount of aluminum oxide and aluminum metal on the can surface following the various treatments (note that verified data for can 6 and can 7 was obtained for cleaning efficiency only). The thickness of the aluminum oxide layer was also calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for can 5, treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2 and 3) and compared to the treatment with nylon beads and water alone (can 4). Furthermore, an aluminum oxide layer of significantly reduced thickness was obtained for can 5 (5.36 nm) compared to the controls and when compared to the treatment with nylon beads and water. This data clearly shows the synergistic interaction of the solid particles and promoters used in the method of the present invention.

TABLE 3
XPS results for cleaning efficiency

| | | Aluminum | Carbon | Aluminum/ |
|---|---|---|---|---|
| | | Metal Content | Content | Carbon |
| Sample | Treatment | (%) | (%) | Ratio |
| Can 1 | Control Can - No | 12.35 | 56.11 | 0.22 |
| | Treatment | | | |
| Can 2 | Water Only | 18.90 | 39.14 | 0.48 |
| Can 3 | Water + Citrate + | 16.86 | 33.17 | 0.51 |
| | non ionic surfactant | | | |
| Can 4 | Nylon + Water | 20.29 | 37.23 | 0.54 |
| Can 5 | Nylon + Water + | 31.38 | 27.96 | 1.12 |
| | Citrate + non- | | | |
| | ionic surfactant | | | |
| Can 6 | Polypropylene + | 23.49 | 33.23 | 0.71 |
| | Water | | | |
| Can 7 | Polypropylene + | 24.59 | 29.02 | 0.85 |
| | Water + Citrate + | | | |
| | non-ionic surfactant | | | |

The data shown in Table 3 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 3 thus indicates that more aluminum is present on the can surface and that more carbon containing material or contaminant residue has been removed. All of the cans treated with the polymeric particles (i.e. cans 4 to 7) show an increase in aluminum/carbon ratio compared to the controls (cans 1 to 3) demonstrating an improved cleaning efficiency. A considerable increase in cleaning performance is shown for cans 5 and 7 which each further include citrate and a non-ionic surfactant in the formulation. In addition, a significant enhancement in cleaning performance was noted for can 6 which comprised treatment with polypropylene polymeric particles and water only.

Experiment 2—Aluminum Cleaning & Oxide Removal Using an Apparatus Fitted with Pumping Means.

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated aluminum metal cans grade ALJSC60ML63X15 were supplied by Invopak UK Ltd. Hyde, Cheshire, UK.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Uri, UK), using relative sensitivity factors based upon the scheme where C1s=1, and adjusted to correct for any minor charging using the aliphatic carbon peak at 285 eV. Each sample was measured in 2 places.

In order to Carry out the experiments, the treatment liquor was added to a vessel containing a pump. The treatment liquor consisted of the polymeric particles (of total mass 10 kg) and tap water (45 kg) and the further formulation components as shown in Table 4. Aluminum cans were fixed to a metal rod which was fixed by means of a clamp. Each can was inserted into the vessel containing the treatment liquor. The cans were then subjected to contact with the pumped liquor for a period of 30 minutes at a temperature of approximately 22° C., ensuring contact between the can and the treatment liquor. After treatment, the cans were washed with Milli-Q™ water and isopropanol and subjected to XPS analysis.

TABLE 4
Sample Details and Formulation Components.

| Sample | Formulation components/treatment |
|---|---|
| Can 1 | Control Can - No Treatment |
| Can 2 | Can Treated With Water Only |
| Can 3 | Water 45 kg + |
| | Citrate 500 g + |
| | Non-ionic Surfactant 25 g |
| Can 4 | Water 45 kg + |
| | Citrate 500 g + |
| | Non-ionic Surfactant 25 g + |
| | Nylon polymeric particles 10 kg |

TABLE 5
XPS results for aluminum oxide removal

| | | | | Aluminum | |
|---|---|---|---|---|---|
| | | Aluminum | Aluminum | Oxide layer | Standard |
| | | Oxide Area | Metal Area | Thickness | Deviation |
| Sample | Treatment | (%) | (%) | (nm) | (%) |
| Can 1 | Control Can - | 97.70 | 2.31 | 11.49 +/− 0.47 | 0.39 |
| | No Treatment | | | | |
| Can 2 | Can Treated With | 94.38 | 5.63 | 8.94 +/− 0.13 | 0.25 |
| | Water Only | | | | |
| Can 3 | Water 45 kg + | 94.46 | 5.54 | 8.99 +/− 0.15 | 0.28 |
| | Citrate 500 g + | | | | |
| | Non-ionic | | | | |
| | Surfactant 25 g | | | | |
| Can 4 | Water 45 kg + | 69.76 | 30.24 | 4.03 +/− 0.02 | 0.17 |
| | Citrate 500 g + | | | | |
| | Non-ionic | | | | |
| | Surfactant 25 g + | | | | |
| | Nylon polymeric | | | | |
| | particles 10 kg | | | | |

The data shown in Table 5 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for can 4, treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2 and 3). Furthermore, an aluminum oxide layer of significantly reduced thickness was obtained for can 4 (4.03 nm) compared to the controls and especially when compared to the treatment with citrate, Mulan™ and water alone. What is also significant is that the reduced thickness aluminum oxide layer for can 4 (i.e. treatment of the can with nylon beads, water, citrate and the non-ionic surfactant) is more homogenous, as the standard deviation is substantially reduced compared to the control samples (i.e. cans 1, 2 and 3).

TABLE 6
XPS results for cleaning efficiency

| | | Aluminum | Carbon | Aluminum/ |
|---|---|---|---|---|
| | | Metal Content | Content | Carbon |
| Sample | Treatment | (%) | (%) | Ratio |
| Can 1 | Control Can - | 15.81 | 35.61 | 0.44 |
| | No Treatment | | | |
| Can 2 | Can Treated With | 17.49 | 41.87 | 0.42 |
| | Water Only | | | |
| Can 3 | Water 45 kg + | 16.84 | 40.94 | 0.41 |
| | Citrate 500 g + | | | |
| | Non-ionic | | | |
| | Surfactant 25 g | | | |
| Can 4 | Water 45 kg + | 40.82 | 19.61 | 2.08 |
| | Citrate 500 g + | | | |
| | Non-ionic | | | |
| | Surfactant 25 g + | | | |
| | Nylon polymeric | | | |
| | particles 10 kg | | | |

The data shown in Table 6 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 6 thus indicates that more aluminum is present on the can surface and that more carbon or contaminant residue has been removed. The can treated with the polymeric particles (i.e. cans 4) showed a significant increase in aluminum/carbon ratio of 2.08 compared to the controls (i.e. cans 1 to 3) demonstrating a dramatically improved cleaning efficiency. The aluminum/carbon ratio for the controls (i.e. cans 1 to 3) were very similar (i.e. in the range 0.41-0.44) which indicated that it was the polymeric particles used that were the essential cleaning component.

The data in Table 7 (below) illustrates the results of XPS analysis for the amounts of other impurities on the aluminum surface, namely calcium, nitrogen and sodium. The can treated with the polymeric particles (i.e. cans 4) indicated removal of calcium, nitrogen and sodium. In comparison, the controls (i.e. cans 1 to 3) showed relatively high levels of these impurities. This demonstrated a dramatically improved cleaning efficiency for the can treated with the polymeric particles (i.e. cans 4) which again indicated that it was the polymeric particles used that were the essential cleaning component.

TABLE 7
XPS results for cleaning efficiency

| | | | | Sodium |
|---|---|---|---|---|
| | | Calcium | Nitrogen Content | Content |
| Sample | Treatment | Content (%) | (%) | (%) |
| Can 1 | Control Can - | 0.23 | 0.93 | 2.75 |
| | No Treatment | | | |
| Can 2 | Can Treated With | 0.58 | 0.83 | 0.40 |
| | Water Only | | | |
| Can 3 | Water 45 kg + | 0.24 | 1.27 | 1.50 |
| | Citrate 500 g + | | | |
| | Non-ionic | | | |
| | Surfactant 25 g | | | |
| Can 4 | Water 45 kg + | 0.00 | 0.00 | 0.00 |
| | Citrate 500 g + | | | |
| | Non-ionic | | | |
| | Surfactant 25 g + | | | |
| | Nylon polymeric | | | |
| | particles 10 kg | | | |

Experiment 3—Steel Cleaning and Iron Oxide Removal Using an Apparatus Fitted with Pumping Means.

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated 1 mm thick mild steel sheet was supplied by Metals 4U Limited, Pontefract, UK.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 8. The mild steel samples were fixed by means of a clamp. Each mild steel sample was inserted into the vessel containing the treatment liquor. The mild steel samples were then subjected to contact with the pumped liquor for a period of 1 or 2 minutes at a temperature of about 22° C., ensuring contact between the mild steel sample and the treatment liquor. After treatment, the mild steel samples were washed with Milli-Q™ water and isopropanol and subjected to XP3 analysis

TABLE 8
Sample Details And Formulation Components.

| Sample | Formulation components/treatment |
|---|---|
| Mild steel 1 | Control - No Treatment |
| Mild steel 2 | Control Treated With Water Only |
| Mild steel 3 | 2 Minute Control Treatment |
| | Water 45 kg + |
| | Citrate 500 g + |
| | Non-ionic Surfactant 25 g |
| Mild steel 4 | 2 Minute Treatment |
| | Water 45 kg + |
| | Citrate 500 g + |
| | Non-ionic Surfactant 25 g + |
| | Nylon polymeric particles 10 kg |
| Mild steel 5 | 1 Minute Control Treatment |
| | Water 45 kg + |
| | Citrate 500 g + |
| | Non-ionic Surfactant 25 g |
| Mild steel 6 | 1 Minute Treatment |
| | Water 45 kg + |
| | Citrate 500 g + |
| | Non-ionic Surfactant 25 g + |
| | Nylon polymeric particles 10 kg |

TABLE 9
XPS results for iron oxide removal

| | | Iron/Iron Oxide |
|---|---|---|
| Sample | Treatment | Ratio |
| Mild steel 1 | Control - No Treatment | 0.03 |
| Mild steel 2 | Control Treated With Water Only | 0.10 |
| Mild steel 3 | 2 Minute Control Treatment | 0.13 |
| | Water 45 kg + | |
| | Citrate 500 g + | |
| | Non-ionic Surfactant 25 g | |
| Mild steel 4 | 2 Minute Treatment | 0.16 |
| | Water 45 kg + | |
| | Citrate 500 g + | |
| | Non-ionic Surfactant 25 g + | |
| | Nylon polymeric particles 10 kg | |
| Mild steel 5 | 1 Minute Control Treatment | 0.14 |
| | Water 45 kg + | |
| | Citrate 500 g + | |
| | Non-ionic Surfactant 25 g | |
| Mild steel 6 | 1 Minute Treatment | 0.16 |
| | Water 45 kg + | |
| | Citrate 500 g + | |
| | Non-ionic Surfactant 25 g + | |
| | Nylon polymeric particles 10 kg | |

The data shown in Table 9 illustrates the results of XPS analysis for the ratio of iron oxide to iron metal on the mild steel surface following the various treatments. As shown by the results for samples 4 and 6 (treatment with nylon particles and formulation for 2 and 1 minutes respectively), compared to control samples without nylon particles there was demonstrated a relative decrease in the iron oxide area (%) and a relative increase in the iron metal area (%), shown by the higher iron/iron oxide ratio compared to the controls. Thus the use of nylon particles has demonstrated good removal of iron oxide from an uncoated mild steel surface.

TABLE 10
XPS results for cleaning efficiency

| | | Iron Metal | | Iron/ |
|---|---|---|---|---|
| | | Content | Carbon | Carbon |
| Sample | Treatment | (%) | Content (%) | Ratio |
| Mild steel 1 | Control - No | 1.61 | 73.90 | 0.02 |
| | Treatment | | | |
| Mild steel 2 | Control Treated | 3.99 | 64.97 | 0.06 |
| | With Water Only | | | |
| Mild steel 3 | 2 Minute Control | 17.43 | 32.55 | 0.54 |
| | Treatment | | | |
| | Water 45 kg + | | | |
| | Citrate 500 g + | | | |
| | Non-ionic | | | |
| | Surfactant 25 g | | | |
| Mild steel 4 | 2 Minute Treatment | 19.91 | 26.88 | 0.74 |
| | Water 45 kg + | | | |
| | Citrate 500 g + | | | |
| | Non-ionic Surfactant | | | |
| | 25 g + | | | |
| | Nylon polymeric | | | |
| | particles 10 kg | | | |
| Mild steel 5 | 1 Minute Control | 14.16 | 36.19 | 0.39 |
| | Treatment | | | |
| | Water 45 kg + | | | |
| | Citrate 500 g + | | | |
| | Non-ionic | | | |
| | Surfactant 25 g | | | |
| Mild steel 6 | 1 Minute Treatment | 20.19 | 28.89 | 0.70 |
| | Water 45 kg + | | | |
| | Citrate 500 g + | | | |
| | Non-ionic Surfactant | | | |
| | 25 g + | | | |
| | Nylon polymeric | | | |
| | particles 10 kg | | | |

The data shown in Table 10 illustrates the results of XPS analysis for the amount of iron metal and carbon on the mild steel surface following the various treatments. The amount of carbon can serve as a surrogate measure for the presence of contaminants (e.g. smut). A higher iron/carbon ratio as indicated in Table 10 thus indicates that more iron is present on the mild steel surface and that more carbon or contaminant residue has been removed. The mild steel sample treated with the polymeric particles for 1 and 2 minutes (i.e. samples 4 and 6) showed a significant increase in iron/carbon ratio of compared to the controls (i.e. mild steel samples 1, 2, 3 and 5) demonstrating an improved cleaning efficiency. Indeed the mild steel samples treated with the formulation without beads for 1 and 2 minutes (i.e. samples 3 and 5) showed a lower iron/carbon ratio than the equivalent mild steel samples treated with the polymeric particles for 1 and 2 minutes (i.e. samples 4 and 6). This indicated that it was the polymeric particles used that were the essential cleaning component in the formulation.

The data in Table 11 illustrates the results of XPS analysis for the amounts of another impurity on the mild steel sample surfaces, namely nitrogen. The mild steel samples treated with the polymeric particles (i.e. mild steel samples 4 and 6) indicated effective removal of nitrogen. In comparison, the controls (i.e. mild steel samples 1, 2, 3 and 5) showed relatively high levels of these nitrogen containing impurities. This demonstrated an improved cleaning efficiency for the mild steel samples treated with the polymeric particles (i.e. samples 4 and 6) even for low treatment periods of 1 and 2 minutes, which again indicated that it was the polymeric particles used that were the essential cleaning component.

TABLE 11
XPS results for cleaning efficiency

| Sample | Treatment | Nitrogen Content (%) |
|---|---|---|
| Mild steel 1 | Control - No Treatment | 0.00 |
| Mild steel 2 | Control Treated With Water Only | 0.81 |
| Mild steel 3 | 2 Minute Control Treatment | 1.14 |
| | Water 45 kg + | |
| | Citrate 500 g + | |
| | Non-ionic Surfactant 25 g | |
| Mild steel 4 | 2 Minute Treatment | 0.00 |
| | Water 45 kg + | |
| | Citrate 500 g + | |
| | Non-ionic Surfactant 25 g + | |
| | Nylon polymeric particles 10 kg | |
| Mild steel 5 | 1 Minute Control Treatment | 0.99 |
| | Water 45 kg + | |
| | Citrate 500 g + | |
| | Non-ionic Surfactant 25 g | |
| Mild steel 6 | 1 Minute Treatment | 0.00 |
| | Water 45 kg + | |
| | Citrate 500 g + | |
| | Non-ionic Surfactant 25 g + | |
| | Nylon polymeric particles 10 kg | |

Experiment 4: Experiments to Investigate Steel Cleaning & Iron Oxide Removal Using an Apparatus Fitted with Pumping Means with Alternative Surfactant, PET Polymer Particles and Benzotriazole Corrosion Inhibitor.

The ingredients were Perlastan™ ON-60 (i.e. 60% aqueous solution of sodium oleoylsarcosinate) (25.0 g), a anionic surfactant supplied by Surfachem Limited, Leeds, UK and the citrate component consisted of trisodium citrate dihydrate (500.0 g) supplied by VWR, Loughborough, UK. The corrosion inhibitor was Surfac™ 8678 (a 1-10% aqueous solution of benzotriazole) supplied by Surfachem Limited, Leeds, UK. The polymeric particles were polyethylene terephthalate (PET) grade 101 supplied by Teknor Apex, UK in the form of beads. The mass of the polymeric particles used in the apparatus was 10 kg. Uncoated 1 mm thick mild steel sheet was supplied by Metals 4U Limited, Pontefract, UK.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 12. The mild steel samples were fixed by means of a clamp. Each mild steel sample was inserted into the vessel containing the treatment liquor. The mild steel samples were then subjected to contact with the pumped liquor for a period of 1 or 2 minutes at a temperature of 22° C., ensuring contact between the mild steel sample and the treatment liquor. After treatment, the mild steel samples were washed with Milli-Q™ water and isopropanol and subjected to XPS analysis.

TABLE 12
Sample Details And Formulation Components.

| Sample | Formulation components/treatment |
|---|---|
| Mild steel 1 | Control - No Treatment |
| Mild steel 2 | Control Treated With Water Only |
| Mild steel 3 | 1 Minute Control Treatment |
| | Water 45 kg + Citrate 500 g + |
| | Perlastan ™ ON-60 25 g + |
| | Surfac ™ B678 25 g |
| Mild steel 4 | 1 Minute Treatment |
| | Water 45 kg + Citrate 500 g + |
| | Perlastan ™ ON-60 25 g + |
| | Surfac ™ B678 25 g + |
| | PET polymeric particles 10 kg |

TABLE 13
XPS results for iron oxide removal

| | | Iron/Iron Oxide |
|---|---|---|
| Sample | Treatment | Ratio |
| Mild steel 1 | Control - No Treatment | 0.03 |
| Mild steel 2 | Control Treated With Water Only | 0.10 |
| Mild steel 3 | 1 Minute Control Treatment | 0.15 |
| | Water 45 kg + | |
| | Citrate 500 g + | |
| | Perlastan ™ ON-60 25 g + | |
| | Surfac ™ B678 25 g | |
| Mild steel 4 | 1 Minute Treatment | 0.16 |
| | Water 45 kg + | |
| | Citrate 500 g + | |
| | Perlastan ™ ON-60 25 g + | |
| | Surfac ™ B678 25 g + | |
| | PET polymeric particles 10 kg | |

The data shown in Table 13 illustrates the results of XPS analysis for the ratio of iron oxide to iron metal on the mild steel surface following the various treatments. As shown by the results for samples 4 (treatment with PET particles and formulation for 1 minute), compared to control samples without PET particles there was demonstrated a decrease in the iron oxide area (%) and an increase in the iron metal area (%), shown by the higher iron/iron oxide ratio compared to the controls. Thus the use of PET particles has demonstrated removal of iron oxide from an uncoated mild steel surface. It should be noted that the mild steel samples were not pre-corroded and were used immediately as supplied.

TABLE 14
XPS results for cleaning efficiency

| | | | Carbon | |
|---|---|---|---|---|
| | | Iron Metal | Content | Iron/Carbon |
| Sample | Treatment | Content (%) | (%) | Ratio |
| Mild steel 1 | Control - No | 1.61 | 73.90 | 0.02 |
| | Treatment | | | |
| Mild steel 2 | Control Treated | 3.99 | 64.97 | 0.06 |
| | With Water Only | | | |
| Mild steel 3 | 1 Minute Control | 8.40 | 43.34 | 0.19 |
| | Treatment | | | |
| | Water 45 kg + | | | |
| | Citrate 500 g + | | | |
| | Perlastan ON-60 | | | |
| | 25 g + | | | |
| | Surfac B678 25 g | | | |
| Mild steel 4 | 1 Minute Treatment | 15.24 | 36.71 | 0.42 |
| | Water 45 kg + | | | |
| | Citrate 500 g + | | | |
| | Perlastan ON-60 | | | |
| | 25 g + | | | |
| | Surfac B678 25 g + | | | |
| | PET polymeric | | | |
| | particles 10 kg | | | |

The data shown in Table 14 illustrates the results of XPS analysis for the amount of iron metal and carbon on the mild steel surface following the various treatments. The amount of carbon can serve as a surrogate measure for the presence of contaminants (e.g. smut). A higher iron/carbon ratio as indicated in Table 14 thus indicates that more iron is present on the mild steel surface and that more carbon or contaminant residue has been removed. The mild steel sample treated with the polymeric particles for 1 minute (i.e. sample 4) showed a significant increase in iron/carbon ratio of compared to the controls (i.e. mild steel samples 1, 2 and 3) demonstrating an improved cleaning efficiency. Indeed the mild steel samples treated with the formulation without beads for 1 minute (i.e. sample 3) showed a lower iron/carbon ratio than the equivalent mild steel samples treated with the polymeric particles for 1 minutes (i.e. sample 4). This indicated that it was the PET polymeric particles used that were an effective cleaning component in the formulation.

The data in Table 15 illustrates the results of XPS analysis for the amounts of another impurity on the mild steel sample surfaces, namely nitrogen and calcium. The mild steel sample treated with the polymeric particles (i.e. mild steel samples 4) indicated effective removal of nitrogen and calcium. In comparison, the controls (i.e. mild steel samples 1, 2 and 3) showed relatively high levels of these nitrogen and calcium containing impurities. This demonstrated an improved cleaning efficiency for the mild steel samples treated with the polymeric particles (i.e. sample 4) even for low treatment periods of 1 minutes, which again indicated that it was the polymeric particles used that were the essential cleaning component.

TABLE 15
XPS results for cleaning efficiency

| | | Calcium | |
|---|---|---|---|
| | | Content | Nitrogen Content |
| Sample | Treatment | (%) | (%) |
| Mild steel 1 | Control - No Treatment | 0.55 | 0.00 |
| Mild steel 2 | Control Treated With | 0.71 | 0.81 |
| | Water Only | | |
| Mild steel 3 | 1 Minute Control Treatment | 1.73 | 1.31 |
| | Water 45 kg + | | |
| | Citrate 500 g + | | |
| | Perlastan ON-60 25 g + | | |
| | Surfac B678 25 g | | |
| Mild steel 4 | 1 Minute Treatment | 0.00 | 0.00 |
| | Water 45 kg + | | |
| | Citrate 500 g + | | |
| | Perlastan ON-60 25 g + | | |
| | Surfac B678 25 g + | | |
| | PET polymeric particles | | |
| | 10 kg | | |

Experiment 5: Experiment to Investigate Iron Oxide Removal from Mild Steel Using an Apparatus Fitted with Pumping Means with Non-Ionic Surfactant and Nylon Polymer Particles.

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated 1 mm thick mild steel sheet was supplied by Metals 4U Limited, Pontefract, UK and were pre-corroded by immersion for 10 seconds in a mixture of 1% w/w sulphuric acid, 0.1% w/w salt and 0.3% w/w hydrogen peroxide followed by washing with deionized water and isopropanol.

XPS analysis was carriod out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 16. The mild steel samples were fixed by means of a clamp. Each mild steel sample was inserted into the vessel containing the treatment liquor. The mild steel samples were then subjected to contact with the pumped liquor for a period of 1, 2 or 5 minutes at a temperature of 22° C., ensuring contact between the mild steel sample and the treatment liquor. After treatment, the mild steel samples were washed with Milli-Q™ water and isopropanol and subjected to XPS analysis.

TABLE 16
Sample Details And Formulation Components.

| Sample | Formulation components/treatment |
|---|---|
| Pre-Corroded Mild | Control - No Treatment |
| steel 1 | |
| Pre-Corroded Mild | Control Treated With Water Only |
| steel 2 | |
| Pre-Corroded Mild | 5 Minute Control Treatment |
| steel 3 | Water 45 kg + |
| | Citrate 500 g + |
| | Non-ionic Surfactant 25 g |
| Pre-Corroded Mild | 5 Minute Treatment |
| steel 4 | Water 45 kg + |
| | Citrate 500 g + |
| | Non-ionic Surfactant 25 g + |
| | Nylon polymeric particles 10 kg |
| Pre-Corroded Mild | 2 Minute Control Treatment |
| steel 5 | Water 45 kg + |
| | Citrate 500 g + |
| | Non-ionic Surfactant 25 g |
| Pre-Corroded Mild | 2 Minute Treatment |
| steel 6 | Water 45 kg + |
| | Citrate 500 g + |
| | Non-ionic Surfactant 25 g + |
| | Nylon polymeric particles 10 kg |
| Pre-Corroded Mild | 1 Minute Control Treatment |
| steel 7 | Water 45 kg + |
| | Citrate 500 g + |
| | Non-ionic Surfactant 25 g |
| Pre-Corroded Mild | 1 Minute Treatment |
| steel 8 | Water 45 kg + |
| | Citrate 500 g + |
| | Non-ionic Surfactant 25 g + |
| | Nylon polymeric particles 10 kg |

TABLE 17
XPS results for iron oxide removal

| | | Iron/Iron |
|---|---|---|
| Sample | Treatment | Oxide Ratio |
| Pre-Corroded | Control - No Treatment | 0.0 |
| Mild steel 1 | | |
| Pre-Corroded | Control Treated With Water Only | 0.0 |
| Mild steel 2 | | |
| Pre-Corroded | 5 Minute Control Treatment | 0.0 |
| Mild steel 3 | Water 45 kg + | |
| | Citrate 500 g + | |
| | Non-ionic Surfactant 25 g | |
| Pre-Corroded | 5 Minute Treatment | 0.14 |
| Mild steel 4 | Water 45 kg + | |
| | Citrate 500 g + | |
| | Non-ionic Surfactant 25 g + | |
| | Nylon polymeric particles 10 kg | |
| Pre-Corroded | 2 Minute Control Treatment | 0.0 |
| Mild steel 5 | Water 45 kg + | |
| | Citrate 500 g + | |
| | Non-ionic Surfactant 25 g | |
| Pre-Corroded | 2 Minute Treatment | 0.07 |
| Mild steel 6 | Water 45 kg + | |
| | Citrate 500 g + | |
| | Non-ionic Surfactant 25 g + | |
| | Nylon polymeric particles 10 kg | |
| Pre-Corroded | 1 Minute Control Treatment | 0.0 |
| Mild steel 7 | Water 45 kg + | |
| | Citrate 500 g + | |
| | Non-ionic Surfactant 25 g | |
| Pre-Corroded | 1 Minute Treatment | 0.05 |
| Mild steel 8 | Water 45 kg + | |
| | Citrate 500 g + | |
| | Non-ionic Surfactant 25 g + | |
| | Nylon polymeric particles 10 kg | |

The data shown in Table 17 illustrates the results of XPS analysis for the ratio of iron oxide to iron metal on the mild steel surface following the various treatments. As shown by the results for samples 4, 6 and 8 (treatment with nylon particles and formulation for 5, 2 and 1 minute respectively), compared to control samples without nylon particles there was demonstrated a decrease in the iron oxide area (%) and an increase in the iron metal area (%), shown by the higher iron/iron oxide ratio compared to the controls. Thus the use of nylon particles has demonstrated removal of iron oxide from an uncoated mild steel surface.

Experiment 6: Further Experiment to Investigate Iron Oxide Removal from Mild Steel Using an Apparatus Fitted with Pumping Means with Alternative Surfactant, PET Polymer Particles and Benzotriazole Corrosion Inhibitor.

The ingredients were Perlastan™ ON-60 (i.e. 60% aqueous solution of sodium oleoylsarcosinate) (25.0 g), a anionic surfactant supplied by Surfachem Limited, Leeds, UK and the citrate component consisted of trisodium citrate dihydrate (500.0 g) supplied by VWR, Loughborough, UK. The corrosion inhibitor was Surfac™ B678 (a 1-10% aqueous solution of benzotriazole) supplied by Surfachem Limited, Leeds, UK. The polymeric particles were polyethylene terephthalate (PET) grade 101 supplied by Teknor Apex, UK in the form of beads. The mass of the polymeric particles used in the apparatus was 10 kg. Uncoated 1 mm thick mild steel sheet was supplied by Metals 4U Limited, Pontefract, UK, and were pre-corroded by immersion for 10 seconds in a mixture of 1% w/w sulphuric acid, 0.1% w/w salt and 0.3% w/w hydrogen peroxide followed by washing with deionized water and isopropanol.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 18. The mild steel samples were fixed by means of a clamp. Each mild steel sample was inserted into the vessel containing the treatment liquor. The mild steel samples were then subjected to contact with the pumped liquor for a period of 1, 5 or 10 minutes at a temperature of 22° C., ensuring contact between the mild steel sample and the treatment liquor. After treatment, the mild steel samples were washed with Milli-Q™ water and isopropanol and subjected to XPS analysis.

TABLE 18
Sample Details And Formulation Components.

| Sample | Formulation components/treatment |
|---|---|
| Pre-Corroded Mild steel 1 | Control - No Treatment |
| Pre-Corroded Mild steel 2 | Control Treated With Water Only |
| Pre-Corroded Mild steel 3 | 10 Minute Control Treatment |
| | Water 45 kg + Citrate 500 g + |
| | Perlastan ™ ON-60 25 g + |
| | Surfac ™ B678 25 g |
| Pre-Corroded Mild steel 4 | 10 Minute Treatment |
| | Water 45 kg + Citrate 500 g + |
| | Perlastan ™ ON-60 25 g + |
| | Surfac ™ B678 25 g + |
| | PET polymeric particles 10 kg |
| Pre-Corroded Mild steel 5 | 5 Minute Control Treatment |
| | Water 45 kg + |
| | Citrate 500 g + |
| | Perlastan ™ ON-60 25 g + |
| | Surfac ™ B678 25 g |
| Pre-Corroded Mild steel 6 | 5 Minute Treatment |
| | Water 45 kg + |
| | Citrate 500 g + |
| | Perlastan ™ ON-60 25 g + |
| | Surfac ™ B678 25 g + |
| | PET polymeric particles 10 kg |
| Pre-Corroded Mild steel 7 | 1 Minute Control Treatment |
| | Water 45 kg + |
| | Citrate 500 g + |
| | Perlastan ™ ON-60 25 g + |
| | Surfac ™ B678 25 g |
| Pre-Corroded Mild steel 8 | 1 Minute Treatment |
| | Water 45 kg + |
| | Citrate 500 g + |
| | Perlastan ™ ON-60 25 g + |
| | Surfac ™ B678 25 g + |
| | PET polymeric particles 10 kg |

TABLE 19
XPS results for iron oxide removal

| | | Iron/ |
|---|---|---|
| | | Iron |
| | | Oxide |
| Sample | Treatment | Ratio |
| Pre-Corroded Mild steel 1 | Control - No Treatment | 0.0 |
| Pre-Corroded Mild steel 2 | Control Treated With Water Only | 0.0 |
| Pre-Corroded Mild steel 3 | 10 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 4 | 10 Minute Treatment | 0.08 |
| | Water 45 kg + Citrate 500 g + | |
| | Perlastan ™ ON-60 25 g + | |
| | Surfac ™ B678 25 g + | |
| | PET polymeric particles 10 kg | |
| Pre-Corroded Mild steel 5 | 5 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 6 | 5 Minute Treatment | 0.04 |
| | Water 45 kg + Citrate 500 g + | |
| | Perlastan ™ ON-60 25 g + | |
| | Surfac ™ B678 25 g + | |
| | PET polymeric particles 10 kg | |
| Pre-Corroded Mild steel 7 | 1 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 8 | 1 Minute Treatment | 0.01 |
| | Water 45 kg + Citrate 500 g + | |
| | Perlastan ™ ON-60 25 g + | |
| | Surfac ™ B678 25 g + | |
| | PET polymeric particles 10 kg | |

The data shown in Table 19 illustrates the results of XPS analysis for the ratio of iron oxide to iron metal on the mild steel surface following the various treatments. As shown by the results for samples 4, 6 and 8 (treatment with polyester PET particles and formulation for 10, 5 and 1 minute respectively), compared to control samples without polyester PET particles there was demonstrated a decrease in the iron oxide area (%) and an increase in the iron metal area (%), shown by the higher iron/iron oxide ratio compared to the controls. Thus the use of polyester PET particles has demonstrated removal of iron oxide from an uncoated mild steel surface.

Experiment 7—Aluminum Cleaning & Oxide Removal Using an Apparatus Fitted with Pumping Means.

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated aluminum metal cans grade ALJSC60ML63X15 were supplied by Invopak UK Ltd. Hyde, Cheshire.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured In 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 20. Aluminum cans were fixed to a metal rod which was fixed by means of a clamp. Each can was inserted into the vessel containing the treatment liquor. The cans were then subjected to contact with the pumped liquor for a period of 1, 2 and 5 minutes at a temperature of approximately 22° C., ensuring contact between the can and the treatment liquor. After treatment, the cans were washed with Milli-Q™ water and isopropanol and subjected to XPS analysis.

TABLE 20
Sample Details And Formulation Components.

| Sample | Formulation components/treatment |
|---|---|
| Can 1 | Control Can - No Treatment |
| Can 2 | Can Treated With Water Only |
| Can 3 | 5 Minute Control |
| | Water 45 kg + |
| | Citrate 500 g + |
| | Non-ionic Surfactant 25 g |
| Can 4 | 5 Minute Treatment |
| | Water 45 kg + |
| | Citrate 500 g + |
| | Non-ionic Surfactant 25 g + |
| | Nylon polymeric particles 10 kg |
| Can 5 | 2 Minute Control |
| | Water 45 kg + |
| | Citrate 500 g + |
| | Non-ionic Surfactant 25 g |
| Can 6 | 2 Minute Treatment |
| | Water 45 kg + |
| | Citrate 500 g + |
| | Non-ionic Surfactant 25 g + |
| | Nylon polymeric particles 10 kg |
| Can 7 | 1 Minute Control |
| | Water 45 kg + |
| | Citrate 500 g + |
| | Non-ionic Surfactant 25 g |
| Can 8 | 1 Minute Treatment |
| | Water 45 kg + |
| | Citrate 500 g + |
| | Non-ionic Surfactant 25 g + |
| | Nylon polymeric particles 10 kg |

TABLE 21
XPS results for aluminum oxide removal

| | | | | Aluminum |
|---|---|---|---|---|
| | | Aluminum | Aluminum | Oxide |
| | | Oxide | Metal | layer |
| | | Area | Area | Thickness |
| Sample | Treatment | (%) | (%) | (nm) |
| Can 1 | Control Can - No | 97.70 | 2.31 | 11.49 |
| | Treatment | | | |
| Can 2 | Can Treated With Water | 94.38 | 5.63 | 8.94 |
| | Only | | | |
| Can 3 | 5 Minute Control | 95.74 | 4.26 | 9.73 |
| | Water 45 kg + | | | |
| | Citrate 500 g + | | | |
| | Non-ionic Surfactant 25 g | | | |
| Can 4 | 5 Minute Treatment | 79.24 | 20.75 | 5.16 |
| | Water 45 kg + | | | |
| | Citrate 500 g + | | | |
| | Non-ionic Surfactant 25 g + | | | |
| | Nylon polymeric | | | |
| | particles 10 kg | | | |
| Can 5 | 2 Minute Control | 91.60 | 8.39 | 7.80 |
| | Water 45 kg + | | | |
| | Citrate 500 g + | | | |
| | Non-ionic Surfactant 25 g | | | |
| Can 6 | 2 Minute Treatment | 83.30 | 16.71 | 5.80 |
| | Water 45 kg + | | | |
| | Citrate 500 g + | | | |
| | Non-ionic Surfactant 25 g + | | | |
| | Nylon polymeric | | | |
| | particles 10 kg | | | |
| Can 7 | 1 Minute Control | 96.64 | 3.36 | 10.40 |
| | Water 45 kg + | | | |
| | Citrate 500 g + | | | |
| | Non-ionic Surfactant 25 g | | | |
| Can 8 | 1 Minute Treatment | 66.59 | 33.41 | 3.72 |
| | Water 45 kg + | | | |
| | Citrate 500 g + | | | |
| | Non-ionic Surfactant 25 g + | | | |
| | Nylon polymeric | | | |
| | particles 10 kg | | | |

The data shown in Table 21 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for can 4, 6 and 8 treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2, 3, 5 and 7). Furthermore, an aluminum oxide layer of significantly reduced thickness was obtained for can 8 (3.72 nm) which was subjected only to 1 minute treatment compared to the controls and especially when compared to the treatment with citrate, Mulan™ and water alone for 1 minute (Can 7).

TABLE 22
XPS results for cleaning efficiency

| | | Aluminum | Carbon | |
|---|---|---|---|---|
| | | Metal Content | Content | Aluminum/Carbon |
| Sample | Treatment | (%) | (%) | Ratio |
| Can 1 | Control Can - No Treatment | 15.81 | 35.61 | 0.44 |
| Can 2 | Can Treated With Water Only | 17.49 | 41.87 | 0.42 |
| Can 3 | 5 Minute Control | 18.24 | 28.64 | 0.64 |
| | Water 45 kg + Citrate 500 g + | | | |
| | Non-ionic Surfactant 25 g | | | |
| Can 4 | 5 Minute Treatment | 33.08 | 18.50 | 1.79 |
| | Water 45 kg + Citrate 500 g + | | | |
| | Non-ionic Surfactant 25 g + | | | |
| | Nylon polymeric particles 10 kg | | | |
| Can 5 | 2 Minute Control | 22.07 | 30.44 | 0.72 |
| | Water 45 kg + Citrate 500 g + | | | |
| | Non-ionic Surfactant 25 g | | | |
| Can 6 | 2 Minute Treatment | 31.63 | 20.37 | 1.55 |
| | Water 45 kg + Citrate 500 g + | | | |
| | Non-ionic Surfactant 25 g + | | | |
| | Nylon polymeric particles 10 kg | | | |
| Can 7 | 1 Minute Control | 17.72 | 31.39 | 0.56 |
| | Water 45 kg + Citrate 500 g + | | | |
| | Non-ionic Surfactant 25 g | | | |
| Can 8 | 1 Minute Treatment | 39.13 | 18.30 | 2.14 |
| | Water 45 kg + Citrate 500 g + | | | |
| | Non-ionic Surfactant 25 g + | | | |
| | Nylon polymeric particles 10 kg | | | |

The data shown in Table 22 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 22 thus indicates that more aluminum is present on the can surface and that more carbon or contaminant residue has been removed. The cans treated with the polymeric particles (i.e. cans 4, 6 and 8) showed a significant increase in aluminum/carbon ratio compared to the controls (i.e. cans 1, 2, 3, 5 and 7) demonstrating a dramatically improved cleaning efficiency.

TABLE 23
XPS results for cleaning efficiency

| | | Nitrogen | Sodium |
|---|---|---|---|
| Sample | Treatment | Content (%) | Content (%) |
| Can 1 | Control Can - No Treatment | 0.93 | 2.75 |
| Can 2 | Can Treated With Water Only | 0.83 | 0.40 |
| Can 3 | 5 Minute Control | 1.47 | 3.56 |
| | Water 45 kg + Citrate 500 g + | | |
| | Non-ionic Surfactant 25 g | | |
| Can 4 | 5 Minute Treatment | 0.0 | 0.39 |
| | Water 45 kg + Citrate 500 g + | | |
| | Non-ionic Surfactant 25 g + | | |
| | Nylon polymeric particles 10 kg | | |
| Can 5 | 2 Minute Control | 0.45 | 2.21 |
| | Water 45 kg + Citrate 500 g + | | |
| | Non-ionic Surfactant 25 g | | |
| Can 6 | 2 Minute Treatment | 0.0 | 0.18 |
| | Water 45 kg + Citrate 500 g + | | |
| | Non-ionic Surfactant 25 g + | | |
| | Nylon polymeric particles 10 kg | | |
| Can 7 | 1 Minute Control | 0.35 | 4.03 |
| | Water 45 kg + Citrate 500 g + | | |
| | Non-ionic Surfactant 25 g | | |
| Can 8 | 1 Minute Treatment | 0.0 | 0.0 |
| | Water 45 kg + Citrate 500 g + | | |
| | Non-ionic Surfactant 25 g + | | |
| | Nylon polymeric particles 10 kg | | |

The data in Table 23 (above) illustrates the results of XPS analysis for the amounts of other impurities on the aluminum surface, namely nitrogen and sodium. The cans treated with the polymeric particles (i.e. cans 4, 6 and 8) indicated effective removal of nitrogen and sodium. In comparison, the controls showed relatively high levels of these impurities. This demonstrated a dramatically improved cleaning efficiency for the cans treated with the polymeric particles (i.e. cans 4, 6 and 8) which again indicated that it was the polymeric particles used that were the essential cleaning component.

Experiment 8—Aluminum Cleaning & Oxide Removal Using an Apparatus Fitted with Pumping Means.

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Polyester (PET) supplied by Teknor Apex, UK, in the form of beads. The mass of the polymeric particles used in the apparatus was 10 kg. Uncoated aluminum metal cans grade ALJSC60ML63X15 were supplied by Invopak UK Ltd. Hyde, Cheshire.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 24. Aluminum cans were fixed to a metal rod which was fixed by means of a clamp. Each can was inserted into the vessel containing the treatment liquor. The cans were then subjected to contact with the pumped liquor for a period of 1, 2 and 5 minutes at a temperature of approximately 22° C., ensuring contact between the can and the treatment liquor. After treatment, the cans were washed with Milli-Q™ water and isopropanol and subjected to XPS analysis.

TABLE 24
Sample Details and Formulation Components.

| Sample | Formulation components/treatment |
|---|---|
| Can 1 | Control Can - No Treatment |
| Can 2 | Can Treated With Water Only |
| Can 3 | 5 Minute Control |
| | Water 45 kg + |
| | Citrate 500 g + |
| | Non-ionic Surfactant 25 g |
| Can 4 | 5 Minute Treatment |
| | Water 45 kg + |
| | Citrate 500 g + |
| | Non-ionic Surfactant 25 g + |
| | PET polymeric particles 10 kg |
| Can 5 | 2 Minute Control |
| | Water 45 kg + |
| | Citrate 500 g + |
| | Non-ionic Surfactant 25 g |
| Can 6 | 2 Minute Treatment |
| | Water 45 kg + |
| | Citrate 500 g + |
| | Non-ionic Surfactant 25 g + |
| | PET polymeric particles 10 kg |
| Can 7 | 1 Minute Control |
| | Water 45 kg + |
| | Citrate 500 g + |
| | Non-ionic Surfactant 25 g |
| Can 8 | 1 Minute Treatment |
| | Water 45 kg + |
| | Citrate 500 g + |
| | Non-ionic Surfactant 25 g + |
| | PET polymeric particles 10 kg |

TABLE 25
XPS results for aluminum oxide removal

| | | | | Aluminum |
|---|---|---|---|---|
| | | Aluminum | Aluminum | Oxide layer |
| | | Oxide | Metal | Thickness |
| Sample | Treatment | Area (%) | Area (%) | (nm) |
| Can 1 | Control Can - No | 97.70 | 2.31 | 11.49 |
| | Treatment | | | |
| Can 2 | Can Treated With | 94.38 | 5.63 | 8.94 |
| | Water Only | | | |
| Can 3 | 5 Minute Control | 95.74 | 4.26 | 9.73 |
| | Water 45 kg + | | | |
| | Citrate 500 g + | | | |
| | Non-ionic Surfactant | | | |
| | 25 g | | | |
| Can 4 | 5 Minute Treatment | 84.16 | 15.85 | 5.96 |
| | Water 45 kg + | | | |
| | Citrate 500 g + | | | |
| | Non-ionic Surfactant | | | |
| | 25 g + | | | |
| | PET polymeric | | | |
| | particles 10 kg | | | |
| Can 5 | 1 Minute Control | 96.64 | 3.36 | 10.40 |
| | Water 45 kg + | | | |
| | Citrate 500 g + | | | |
| | Non-ionic Surfactant | | | |
| | 25 g | | | |
| Can 6 | 1 Minute Treatment | 89.99 | 10.01 | 7.92 |
| | Water 45 kg + | | | |
| | Citrate 500 g + | | | |
| | Non-ionic Surfactant | | | |
| | 25 g + | | | |
| | PET polymeric | | | |
| | particles 10 kg | | | |

The data shown in Table 25 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for cans 4 and 6 treatment of the can with PET beads, water, citrate and the non-ionic surfactant demonstrated a significant decrease in the aluminum oxide area (%) and a significant increase in the aluminum metal area (%) for the surface of the metal substrate compared to the controls.

TABLE 26
XPS results for cleaning efficiency

| | | Alu- | | |
|---|---|---|---|---|
| | | minum | | |
| | | Metal | Carbon | Aluminum/ |
| | | Content | Content | Carbon |
| Sample | Treatment | (%) | (%) | Ratio |
| Can 1 | Control Can - No Treatment | 15.81 | 35.61 | 0.44 |
| Can 2 | Can Treated With Water Only | 17.49 | 41.87 | 0.42 |
| Can 3 | 5 Minute Control | 18.24 | 28.64 | 0.64 |
| | Water 45 kg + | | | |
| | Citrate 500 g + | | | |
| | Non-ionic Surfactant 25 g | | | |
| Can 4 | 5 Minute Treatment | 33.16 | 19.51 | 1.70 |
| | Water 45 kg + | | | |
| | Citrate 500 g + | | | |
| | Non-ionic Surfactant 25 g + | | | |
| | PET polymeric particles 10 kg | | | |
| Can 5 | 1 Minute Control | 17.72 | 31.39 | 0.56 |
| | Water 45 kg + | | | |
| | Citrate 500 g + | | | |
| | Non-ionic Surfactant 25 g | | | |
| Can 6 | 1 Minute Treatment | 26.04 | 22.70 | 1.15 |
| | Water 45 kg + | | | |
| | Citrate 500 g + | | | |
| | Non-ionic Surfactant 25 g + | | | |
| | PET polymeric particles 10 kg | | | |

The data shown in Table 26 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 26 thus indicates that more aluminum is present on the can surface and that more carbon or contaminant residue has been removed. The cans treated with the polymeric particles showed a significant increase in aluminum/carbon ratio compared to the controls demonstrating a dramatically improved cleaning efficiency.

### Experiment 9 —Mild Steel Cleaning & Oxide Removal Using an Apparatus Comprising a Rotating Drum and a Stationary Metal Substrate.

The ingredients were Mulan™ 200S (0.6 g), a non-ionic surfactant supplied by Christeyns, Bradford, UK and the citrate component consisted of trisodium citrate dihydrate (12.0 g) supplied by VWR, Loughborough, UK. The corrosion inhibitor was Surfac™ B678 (a 1-10% aqueous solution of benzotriazole) supplied by Surfachem Limited, Leeds, UK which was added to the liquid components in an amount of 0.5 g. Water was added to these ingredients so as to make the total mass of the treatment formulation up to 100 g (excluding the polymeric particles). The polymeric particles were Nylon 6,6 grade Technyl™ XA1493 supplied by Solvay, Lyon, France in the form of beads. The mass of the polymeric particles used in the apparatus was 1.7 kg. Mild steel 1 mm think sheet was used as the metal substrate. This prepared a treatment liquor.

Uncoated 1 mm thick mild steel sheet was supplied by Metals 4U Limited, Pontefract, UK and was pre-corroded by immersion for 10 seconds in a mixture of 1% w/w sulphuric acid, 0.1% w/w salt and 0.3% w/w hydrogen peroxide followed by washing with deionized water and isopropanol.

The treatment apparatus used was a BK-0057 rotary tumbler (obtained from geographysuperstore.com). The treatment apparatus was a 5 kg machine fitted with a drum of dimensions 192 mm×180 mm and having a 2 litre capacity. The treatment liquor prepared above in this experiment was loaded into the treatment apparatus.

The pre-corroded mild steel metal substrate was treated in a treatment apparatus comprising a rotating drum filled with the polymeric particles and the liquid components. A portion of the pre-corroded mild steel substrate was covered with a plastic tape. The presence of the plastic tape prevented the beads and liquid components from contacting some of the metal surface thereby helping to show the contrast between treated and untreated surfaces. The drum was rotated for a period of 10 minutes in such a fashion that the polymeric particles contacted the surface of the mild steel.

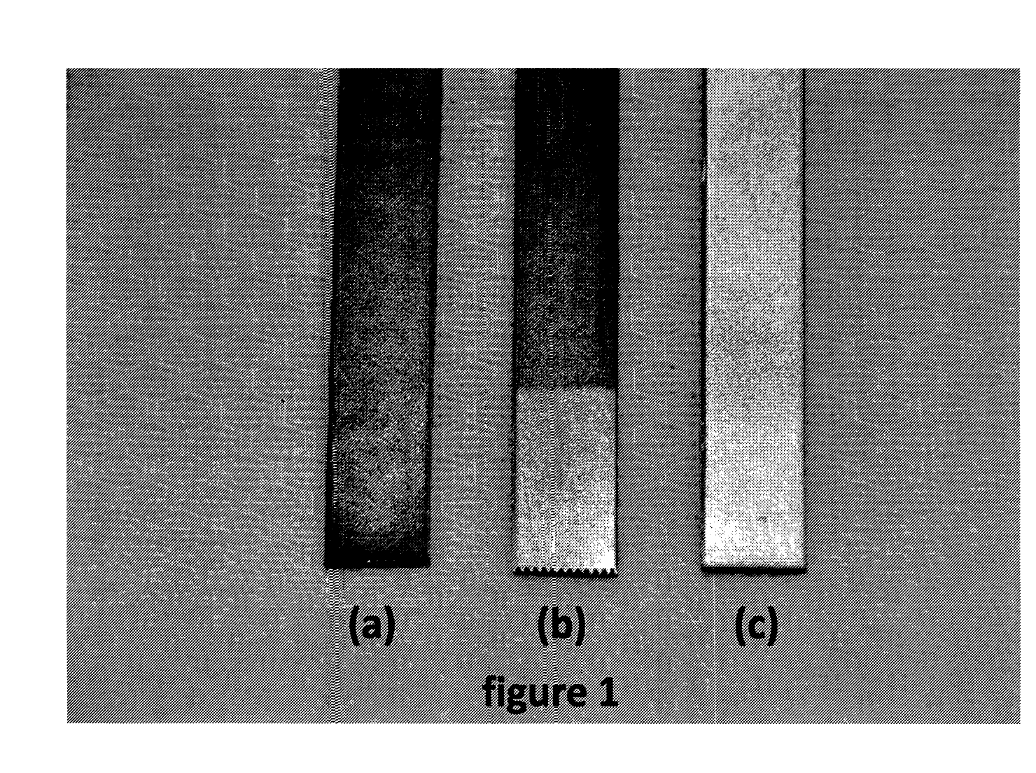

Digital photographs were taken of the un-corroded mild steel substrate, the pre-corroded mild steel substrate and the pre-corroded substrate as treated in this experiment. The results are shown in FIG. 1 wherein (a) is the pre-corroded mild steel substrate, (b) is the pre-corroded mild steel substrate treated as indicated in this experiment and (c) is the un-corroded mild steel substrate. As can be seen from FIG. 1 the pre-corroded mild steel substrate has been successfully cleaned and the pre-corroded oxide layer has been successfully removed. Using a qualitative visual assessment for the remaining amount of oxide layer, the results indicated in Table 27 were obtained.

TABLE 27
Visual assessment of the treatment performance using a treatment
apparatus comprising a rotating drum.

| Sample | Visual assessment* |
|---|---|
| Pre-corroded mild steel | 0 |
| Pre-corroded mild steel treated in | 4 |
| Experiment 9 | |
| Un-corroded mild steel | 5 |

*The visual assessment was performed on a scale of from 0 to 5, with 0 representing the fully pre-corroded surface and 5 representing the “clean” un-corroded mild steel surface.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of removing at least a portion of an oxide layer from the surface of a metal substrate comprising exposing the metal substrate to a body of treatment liquor comprising a treatment formulation and a multiplicity of solid particles which comprise or consists of a multiplicity of polymeric particles and wherein said treatment formulation comprises one or more promoters selected from the group consisting of acids, bases and surfactants wherein the method further comprises causing the solid particles and the metal substrate to enter into contacting relative movement.

2. The method according to claim 1 wherein the treatment formulation further comprises a solvent.

3. The method according to claim 1 or 2 wherein the acids have a pKa greater than about −1.7.

4. The method according to any one of the preceding claims wherein the one or more promoters comprise at least one organic acid.

5. The method according to any of the preceding claims wherein the bases have a pKb greater than about −1.7.

6. The method according to any one of the preceding claims wherein the one or more promoters comprise at least one carboxylic acid moiety.

7. The method according to any one of the preceding claims wherein the one or more promoters comprise two or more carboxylic acid moieties.

8. The method according to any one of the preceding claims wherein the one or more promoters comprise at least one citrate moiety.

9. The method according to any one of the preceding claims wherein the one or more promoters comprise at least one metal chelating agent.

10. The method according to any one of the preceding claims wherein the one or more promoters comprise at least one surfactant.

11. The method according to claim 10 wherein the at least one surfactant is a non-ionic surfactant.

12. The method according to any one of the preceding claims wherein the treatment formulation has a pH between about 1 and about 13.

13. The method according to any one of the preceding claims wherein the treatment formulation has a pH greater than about 7.

14. The method according to any one of the preceding claims wherein the treatment formulation is aqueous.

15. The method according to any one of the preceding claims wherein at least some of the solid particles are buoyant in the treatment formulation.

16. The method according to any one of the preceding claims wherein the solid particles have an average density of less than about 1.

17. The method according to any one of the preceding claims wherein the solid particles are in the form of beads.

18. The method according to any one of the preceding claims wherein the method comprises moving the metal substrate such that its surface is brought into contact with the solid particles.

19. The method according to claim 18 wherein the method comprises rotating, oscillating or reciprocating the metal substrate within the treatment liquor.

20. The method according to any one of the preceding claims wherein the method comprises scouring the surface of the metal substrate with the solid particles.

21. The method according to any one of the preceding claims wherein the method comprises agitating the solid particles within the treatment liquor.

22. The method according to any one of the preceding claims wherein the method is carried out using a fluidized bed containing the treatment liquor.

23. The method according to any one of the preceding claims wherein the treatment liquor contacts the metal surface at a relative velocity of at least 1cm per second.

24. The method according to any one of the preceding claims wherein the multiplicity of solid particles comprises or consists of a mixture of a multiplicity of polymeric particles and a multiplicity of non-polymeric particles.

25. The method according to any one of the preceding claims wherein the polymeric particles comprise particles of one or more polar polymers.

26. The method according to any one of the preceding claims wherein the polymeric particles comprise particles of one or more non-polar polymers.

27. The method according to any one of the preceding claims wherein the polymeric particles comprise particles of one or more polar polymers and particles of one or more non-polar polymers.

28. The method according to any one of the preceding claims wherein the polymeric particles comprise particles selected from particles of polyalkenes, polyamides, polyesters, polysiloxanes, polyurethanes or copolymers thereof.

29. The method according to any of claim 28 wherein the polymeric particles comprise particles selected from particles of polyalkenes or copolymers thereof.

30. The method according to claim 29 wherein the polymeric particles comprise particles of polypropylene.

31. The method according to claim 28, wherein the polymeric particles comprise particles selected from polyamide, polyester and copolymers thereof.

32. The method according to claim 31 wherein the polyamide particles comprise particles of nylon.

33. The method according to claim 31 wherein the polyester particles comprise particles of polyethylene terephthalate or polybutylene terephthalate.

34. The method according to claim 24 wherein the non-polymeric particles comprise particles of ceramic material, refractory material, igneous, sedimentary, metamorphic minerals or composites.

35. The method according to any one of the preceding claims wherein the polymeric particles comprise particles selected from particles comprising linear, branched or cross-linked polymers.

36. The method according to any one of the preceding claims wherein the polymeric particles comprise foamed or unfoamed polymers.

37. The method according to any one of the preceding claims wherein the solid particles are of hollow and/or porous construction.

38. The method according to any one of the preceding claims wherein the polymeric particles have an average density of from about 0.5 to about 3.5 g/cm³.

39. The method according to claim 24 or claim 34 wherein the non-polymeric particles have an average density of from 3.5 to 12.0 g/cm³.

40. The method according to any one of the preceding claims wherein the polymeric particles have a volume in the range of about 5 to about 275 mm³.

41. The method according to any one of the preceding claims wherein the solid particles are reused one or more times for treatment of metal substrates according to the method of the invention.

42. The method according to any one of the preceding claims wherein the method comprises a step of recovering the multiplicity of solid particles after treatment of the metal substrate,

43. The method according to any one of the preceding claims wherein the treatment formulation is substantially free from hydrofluoric acid.

44. The method according to any one of the preceding claims wherein the treatment formulation comprises one or more components selected from the group consisting of: polymers, corrosion inhibitors, builders, dispersants, anti-oxidants, reducing agents, oxidising agents and bleaches.

45. The method according to any one of the preceding claims wherein the method comprises passivating the metal substrate.

46. The method according to any one of the preceding claims wherein the method comprises inhibiting the re-growth of an oxide layer on the surface of the metal substrate.

47. The method according to any one of the preceding claims wherein the method further comprises coating the metal substrate after the removal of at least a portion of the oxide layer.

48. The method according to any one of the preceding claims wherein the metal substrate comprises a transition metal.

49. The method according to any one of the preceding claims wherein the metal substrate comprises aluminum.

50. The method according to any one of the preceding claims wherein the metal substrate is a metal alloy.

51. The method according to claim 50 wherein the metal alloy is an alloy of iron.

52. The method according to any one of the preceding claims wherein the metal substrate comprises a metal sheet.

53. The method according to any one of the preceding claims wherein the metal substrate is a can.

54. A method according to any one of the preceding claims further comprising, prior to the removal of at least a portion of the oxide layer from the metal substrate, cleaning the metal substrate to remove surface contaminants.

55. The method according to claim 54 wherein cleaning the metal substrate comprises cleaning the metal substrate with a cleaning liquor comprising a cleaning formulation and a multiplicity of solid particles.

56. The method according to claim 55 wherein the cleaning step further comprises causing the solid particles and the metal substrate to enter into contacting relative movement.

57. The method according to claim 55 or 56 wherein the cleaning formulation is aqueous.

58. The method according to any one of claim 55, 56 or 57 wherein the cleaning formulation comprises at least one surfactant.

59. The method according to any of claims 55 to 58 wherein the cleaning formulation comprises at least one acid.

60. The method according to any of claims 55 to 59 wherein the cleaning formulation comprises at least one base.

61. The method according to any of claims 55 to 60 wherein the cleaning formulation comprises at least one metal chelating agent.

62. The method according to any of claims 55 to 61 wherein the cleaning formulation comprises at least one citrate moiety.

63. The method according to any of claims 55 to 62 wherein the solid particles comprise or consist of a multiplicity of polymeric particles or wherein the solid particles in the cleaning liquor comprises or consists of a multiplicity of non-polymeric particles.

64. The method according to any of claims 56 to 64 wherein the solid particles in the cleaning liquor comprises or consists of a multiplicity of polymeric particles.

65. The method according to any one of the preceding claims wherein the metal substrate is exposed to the treatment liquor from a period of from 1 second to 4 minutes.

66. A metal substrate obtainable by any of claims 1 to 65.

67. The metal substrate of claim 66 wherein the metal substrate comprises an oxide layer with a thickness of less than 15 nm as measured by X-ray photoelectron spectroscopy.

68. The metal substrate of claim 66 wherein the metal substrate comprises an oxide layer with a thickness of less than 10 nm as measured by X-ray photoelectron spectroscopy.

69. The metal substrate of claim 66 wherein the metal substrate comprises an oxide layer with a thickness of less than 5.4 nm as measured by X-ray photoelectron spectroscopy.

70. A treatment liquor for removing at least a portion of an oxide layer from the surface of a metal substrate comprising a treatment formulation and a multiplicity of solid particles which comprise or consists of a multiplicity of polymeric particles wherein said treatment formulation comprises one or more promoters selected from the group consisting of acids, bases and surfactants, wherein said treatment formulation comprises:
i) one or more promoters comprising at least one carboxylic acid moiety;
ii) one or more promoters comprising at least one surfactant;
and wherein the particles have a length of from about 0.5 to about 6 mm.

71. A treatment liquor according to claim 70 wherein the treatment formulation further comprises a solvent

72. A treatment liquor according to claim 70 or claim 71 wherein the acids have a pKa greater than about −1.7.

73. A treatment liquor according to any one of claims 70 to 72 wherein the bases have a pKb greater than about −1.7.

74. A treatment liquor according to any one of claims 70 to 73 wherein one or more promoters comprise at least two carboxylic acid moieties.

75. A treatment liquor according to any one of claims 70 to 74 wherein the one or more promoters comprises at least one citrate moiety.

76. A treatment liquor according claims 75 wherein the promoter comprising at least one citrate moiety is a citrate containing salt.

77. A treatment liquor according to any one of claims 70 to 76 wherein the one or more promoters comprise at least one metal chelating agent.

78. A treatment liquor according to any one of claims 70 to 77 wherein the at least one surfactant is an anionic surfactant.

79. A treatment liquor according to any one of claims 70 to 77 wherein the at least one surfactant is a non-ionic surfactant.

80. A treatment liquor according to any one of claims 70 to 79 wherein the treatment formulation has a pH greater than about 7.

81. A treatment liquor according to any one of claims 70 to 80 wherein the treatment formulation is aqueous.

82. A treatment liquor according to any one of claims 70 to 81 wherein at least some of the polymeric particles are buoyant in the treatment formulation.

83. A treatment liquor according to any one of claims 70 to 82 wherein the polymeric particles have an average density of less than about 1.

84. A treatment liquor according to any one of claims 70 to 83 wherein the polymeric particles are in the form of beads.

85. A treatment liquor according to any one of claims 70 to 84 wherein the multiplicity of solid particles comprises or consists of a mixture of a multiplicity of polymeric particles and a multiplicity of non-polymeric particles.

86. A treatment liquor according to any one of claims 70 to 85 wherein the polymeric particles comprise particles selected from particles of polyalkenes, polyamides, polyesters, polysiloxanes, polyurethanes or copolymers thereof.

87. A treatment liquor according to any one of claims 70 to 86 wherein the treatment formulation is substantially free from hydrofluoric acid.
